(19) United States
(12) Patent Application Publication
(10) Pub. No.: US 2026/0332452 A1
(43) Pub. Date: Oct. 22, 2026

(54) DISCOVERY PROCEDURE ASSOCIATED WITH A VIRTUAL LOCAL AREA NETWORK (VLAN) IDENTITY (ID)

(71) Applicant: QUALCOMM Incorporated, San Diego, CA (US)

(72) Inventors: Sagar DHOOT, Hyderabad (IN); Nagarjuna Reddy CHAGANTI, Hyderabad (IN)

(21) Appl. No.: 19/183,067

(22) Filed: Apr. 18, 2025

(51) Int. Cl. H04L 12/46

(52) U.S. Cl. CPC H04L 12/4675

(57) ABSTRACT

Various aspects of the present disclosure generally relate to wireless communication and to a discovery procedure associated with a virtual local area network (VLAN) identity (ID). A processing system selects, for a discovery procedure associated with an Ethernet port, a first VLAN ID from among a plurality of VLAN IDs. During performance of a first instance of the discovery procedure for the first VLAN ID, the processing system detects that a signal quality of an Ethernet channel satisfies a first threshold. Based on a determination that the signal quality of the Ethernet channel satisfies the first threshold, the processing system halts performance of the first instance of the discovery procedure. Based on a determination that the signal quality of the Ethernet channel satisfies a second threshold, the processing system performs a second instance of the discovery procedure for the first VLAN ID.

### FIELD OF THE DISCLOSURE

Aspects of the present disclosure relate generally to wireless communication systems, and more particularly, to a discovery procedure associated with a virtual local area network (VLAN) identity (ID) in wireless communication systems.

### BACKGROUND

Wireless communications systems are widely deployed to provide various types of services such as voice, video, packet data, messaging, broadcast, and other types of traffic. The services may include unicast, multicast, and/or broadcast services, among other examples. Typical wireless communication systems may support multiple-access radio access technologies and include a number of base stations or network nodes, each supporting communication for multiple communication devices, which may be otherwise known as user equipment (UE). These systems may be capable of supporting communication with multiple users by sharing available system resources (such as time domain resources, frequency domain resources, spatial domain resources, and device transmit power, among other examples). These systems may employ multiple-access technologies such as code division multiple access (CDMA) technology, time division multiple access (TDMA) technology, frequency division multiple access (FDMA) technology, orthogonal frequency division multiple access (OFDMA) technology, discrete Fourier transform spread orthogonal frequency division multiplexing (DFT-S-OFDM) technology, single-carrier frequency division multiple access (SC-FDMA) technology, and time division synchronous code division multiple access (TD-SCDMA) technology.

The above multiple-access technologies have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, carrier aggregation, high-precision positioning, and/or radio frequency (RF) sensing, among other examples. As the demand for mobile broadband access continues to increase, further improvements in NR may be implemented, and other radio access technologies, such as 6G, may be introduced to further advance mobile broadband evolution.

Another example telecommunication standard is the open radio access network (O-RAN) standard. An O-RAN communication network can include radio units (RU) that are communicatively coupled with distributed units (DU) via an open fronthaul interface. The open fronthaul interface includes a management (M)-plane through which the DU manages one or more operations of the RU. To establish the M-plane, the RU implements the ETSI technical standard (TS) 104 023 (O-RAN Fronthaul Management Plane Specification).

In conventional techniques to establish the M-plane, for at least one Ethernet ports of the RU that is configured for a trunk mode operation, the RU identifies a virtual local area network (VLAN) identity (ID) that supports M-plane communication. To identify the VLAN ID that supports the M-plane communication, the RU sequentially performs a dynamic host configuration protocol (DHCP) discovery procedure for each VLAN ID of multiple VLAN IDs until the RU identifies a VLAN ID to associate with an Internet protocol (IP) address. During the DHCP discovery procedure, the RU continues to perform the DHCP discovery procedure for one or more additional VLAN IDs independent of whether or not an Ethernet link between the RU and the DU is stable or unstable. For example, when the Ethernet link is unstable, RU continues the discovery procedure for one or more VLAN IDs are unable to be completed because of the instability of the Ethernet link. Accordingly, when the RU has performed the DHCP discovery procedure for all VLAN IDs of an Ethernet port, the RU re-performs the DHCP discovery procedure for all the VLAN IDs in an effort to complete the DHCP discovery procedure for each of the VLAN IDs. Re-performing instances of the discovery procedure from the first VLAN ID is time consuming and delays establishment of M-plane communication.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to one implementation of the present disclosure, a device includes a processing system coupled to a plurality of Ethernet ports. The processing system includes one or more processors and one or more memories coupled to the one or more processors. The processing system is configured to select, for a discovery procedure associated with an Ethernet port of the plurality of Ethernet ports, a first virtual local area network (VLAN) identity (ID) from among a plurality of VLAN IDs. The processing system is also configured to, during performance of a first instance of the discovery procedure for the first VLAN ID, detect that a signal quality of an Ethernet channel satisfies a first threshold. The Ethernet channel is established with a server device. Further, based on a determination that the signal quality of the Ethernet channel satisfies the first threshold, the processing system is configured to halt the performance of the first instance of the discovery procedure. Based on a determination that the signal quality of the Ethernet channel satisfies a second threshold, the processing system is configured to perform a second instance of the discovery procedure for the first VLAN ID.

According to another implementation of the present disclosure, a method is performed by a client device. The method includes selecting, for a discovery procedure associated with an Ethernet port of the client device, a first VLAN ID from among a plurality of VLAN IDs. The method further includes, during performance of a first instance of the discovery procedure for the first VLAN ID, determining that a signal quality of an Ethernet channel satisfies a first threshold. The Ethernet channel is established with a server device. The method also includes, based on determining that the signal quality of the Ethernet channel satisfies the first threshold, halting performing the first instance of the discovery procedure. The method includes based on determining that the signal quality of the Ethernet channel satisfies a second threshold, performing a second instance of the discovery procedure for the first VLAN ID.

According to another implementation of the present disclosure, disclosed is a non-transitory computer-readable medium storing instructions that are executable by one or more processors to cause the one or more processors to perform operations. The operations include selecting, for a discovery procedure associated with an Ethernet port, a first VLAN ID from among a plurality of VLAN IDs. The operations further include, during performance of a first instance of the discovery procedure for the first VLAN ID, detecting that a signal quality of an Ethernet channel satisfies a first threshold. The Ethernet channel is established with a server device. The operations include, based on detecting that the signal quality of the Ethernet channel satisfies the first threshold, halting performance of the first instance of the discovery procedure. The operations include, based on detecting that the signal quality of the Ethernet channel satisfies a second threshold, performing a second instance of the discovery procedure for the first VLAN ID.

According to another implementation of the present disclosure, an apparatus is disclosed. The apparatus includes means for selecting, for a discovery procedure associated with an Ethernet port of the apparatus, a first VLAN ID from among a plurality of VLAN IDs. The apparatus further includes means for determining, during performance of a first instance of the discovery procedure for the first VLAN ID, that a signal quality of an Ethernet channel satisfies a first threshold, the Ethernet channel established with a server device. The apparatus also includes means for halting, based on determining that the signal quality of the Ethernet channel satisfies the first threshold, performance of the first instance of the discovery procedure. The apparatus includes means for performing, based on determining that the signal quality of the Ethernet channel satisfies a second threshold, a second instance of the discovery procedure for the first VLAN ID.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, methods, and computer-readable media.

### BRIEF DESCRIPTION OF THE DRAWINGS

A further understanding of the nature and advantages of the present disclosure may be realized by reference to the following drawings. In the appended figures, similar components or features may have the same reference label and designations. Further, various components of the same type may be distinguished by following the reference label by a dash and a second label that distinguishes among the similar components, or by following the reference label with a letter. If just the first reference label is used in the specification, the description is applicable to any one of the similar components having the same first reference label irrespective of the second reference label or letter.

FIG. 1 is a block diagram illustrating details of an example wireless communication network in accordance with the present disclosure.

FIG. 2 is a block diagram illustrating examples of a network node and a user equipment (UE) in accordance with the present disclosure.

FIG. 3 is a block diagram illustrating an example disaggregated base station architecture in accordance with the present disclosure.

FIG. 4 is a block diagram illustrating an example of a wireless communication system that supports a discovery procedure associated with a virtual local area network (VLAN) identity (ID) in accordance with the present disclosure.

FIG. 5 is a ladder diagram of an example of operations that supports a discovery procedure associated with a VLAN ID in accordance with the present disclosure.

FIG. 6 is a ladder diagram of an example of operations that supports a discovery procedure associated with a VLAN ID in accordance with the present disclosure.

FIG. 7 is a ladder diagram of an example of operations that supports a discovery procedure associated with a VLAN ID in accordance with the present disclosure.

FIG. 8 is a flow diagram illustrating an example process that supports a discovery procedure associated with a VLAN ID in accordance with the present disclosure.

FIG. 9 is a block diagram of an example network node that supports a discovery procedure associated with a VLAN ID in accordance with the present disclosure.

### DETAILED DESCRIPTION

Various aspects of the disclosure are described more fully hereinafter with reference to the accompanying drawings. This disclosure may, however, be embodied in many different forms and is not to be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques are described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

The present disclosure provides systems, apparatus, methods, and computer-readable media for a discovery procedure, such as a dynamic host configuration protocol (DHCP), associated with a virtual local area network (VLAN) identity (ID) for wireless communication systems. Some aspects more specifically relate to halting performance, by a network node (e.g., a client device), of a first instance of a discovery procedure performed for a VLAN ID in response to detection, by the network node, of degraded signal quality over an Ethernet channel established between an Ethernet port of the network node and a server device. To illustrate, during performance of the discovery procedure, the network node monitors the Ethernet channel to identify degradation in its signal quality. Based on detection, by the network node, of degraded signal quality, the network node stops performance of the instance of the discovery procedure. Based on detection that the signal quality has improved, the network node performs a second instance of the discovery procedure for the same VLAN ID from which the network node performed the first instance of the discovery procedure. For example, the second instance of the discovery procedure may be a next instance of the discovery procedure after the first instance of the discovery procedure.

Particular implementations of the subject matter described in this disclosure can be implemented to realize one or more of the following potential advantages. In some aspects, the present disclosure provides techniques for improving the temporal efficiency with which a discovery procedure is performed. For example, by halting performance of an instance of the discovery procedure performed for a VLAN ID based on detection of signal quality degradation and performing the second instance of the discovery procedure for the same VLAN ID based on detection of restoration of the signal quality, the network node does not perform one or more instances of the discovery procedure while the signal quality is degraded. Performing instances of the discovery procedure while the signal quality is degraded results in failed instances, requiring re-initiation of the discovery procedure as is conventional techniques. Reducing the amount of time to perform the discovery procedure relative to conventional techniques enables relatively rapid establishment of management (M)-plane communication, thereby facilitating relatively faster communication among devices. Additionally, refraining from performing instances of the discovery procedure on one or more VLAN IDs while the signal quality is degraded conserves power and reduces overhead signaling, since the network node does not consume power performing instances of the discovery procedure that will fail due to the degraded signal quality.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, long term evolution (LTE) networks, Global System for Mobile Communications (GSM) networks, 5th Generation (5G) or new radio (NR) networks (sometimes referred to as “5G NR” networks, systems, or devices), as well as other communications networks. As described herein, the terms “networks” and “systems” may be used interchangeably.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV). 5G NR networks contemplate diverse deployments, diverse spectrum, and diverse services and devices that may be implemented using an OFDM-based unified, air interface. 5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 gigahertz (GHz) FDD or TDD implementations, subcarrier spacing may occur with 15 kilohertz (kHz), for example over 1, 5, 10, 20 megahertz (MHz), and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs allows transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases. For clarity, certain aspects of the present disclosure may be described below with reference to example 5G NR implementations or in a 5G-centric way, and 5G terminology may be used as illustrative examples in portions of the description below; however, the description is not intended to be limited to 5G applications.

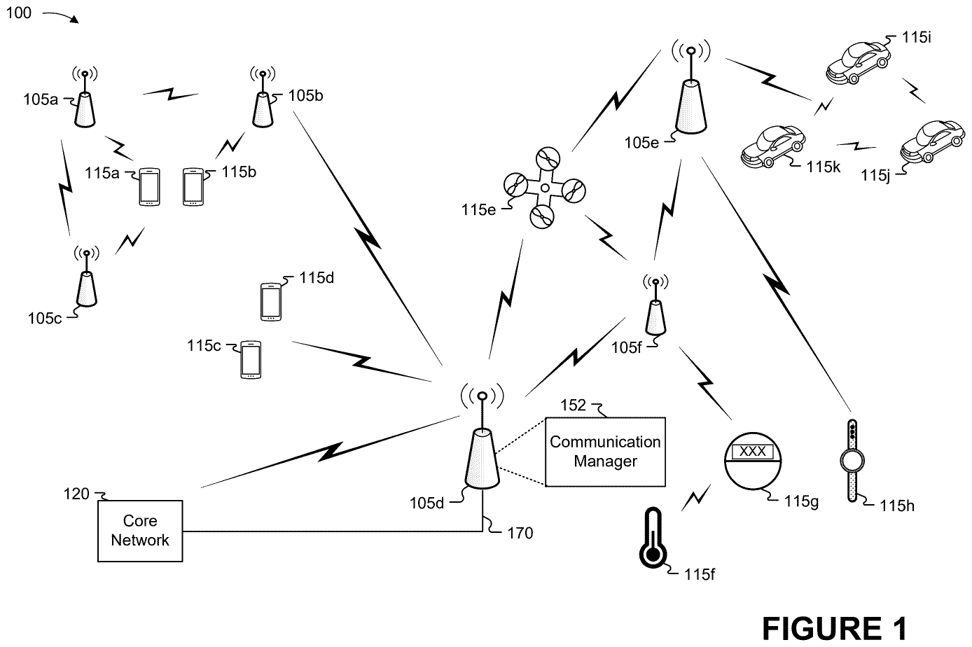

FIG. 1 is a block diagram illustrating details of an example wireless communication network 100 in accordance with the present disclosure. The wireless communication network 100 may, for example, be or include elements of a 5G (or NR) network or a 6G network, among other examples. As appreciated by those skilled in the art, components appearing in FIG. 1 are likely to have related counterparts in other network arrangements including, for example, cellular-style network arrangements and non-cellular-style-network arrangements, such as device-to-device, peer-to-peer, or ad hoc network arrangements, among other examples.

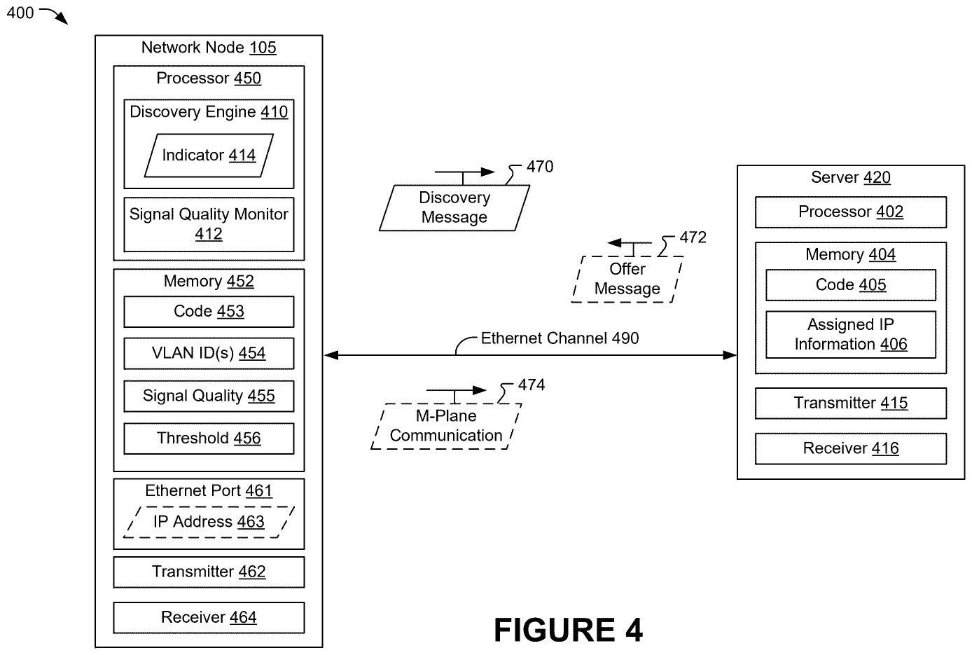

The wireless communication network 100 illustrated in FIG. 1 includes multiple network nodes 105, also referred to as network entities, client devices, radio units (RUs), central units (CUs), distributed units (DUs), and multiple user equipments (UEs) 115. A network node 105 may be a station that communicates with UEs and may be referred to as a base station, an evolved node B (eNB), a next generation eNB (gNB), an access point, and the like. Additionally, a network node, such as network node 105d, may be an RU that communicates via fronthaul link 170 with another device, such as core network 120. The core network 120 may include or correspond to a server device, such as server device 420 described with reference to FIG. 4. Each network node 105 may provide communication coverage for a particular geographic area. In 3GPP, the term “cell” can refer to this particular geographic coverage area of a network node or a network node subsystem serving the coverage area, depending on the context in which the term is used. In implementations of the wireless communication network 100 herein, the network nodes 105 may be associated with a same operator or different operators, such as the wireless communication network 100 may include a plurality of operator wireless networks. In some examples, an individual network node 105 or UE 115 may be operated by more than one network operating entity. In some other examples, each network node 105 and UE 115 may be operated by a single network operating entity.

The network nodes 105 and the UEs 115 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, in accordance with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 105 may include one or more devices, components, or systems that enable communication between a UE 115 and one or more devices, components, or systems of the wireless communication network 100. A network node 105 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 105 may be implemented as a single physical node (for example, a single physical structure) or may be implemented as two or more physical nodes (for example, two or more distinct physical structures). For example, a network node 105 may be a device or system that implements part of a radio protocol stack, a device or system that implements a full radio protocol stack (such as a full gNB protocol stack), or a collection of devices or systems that collectively implement the full radio protocol stack. For example, and as shown, a network node 105 may be an aggregated network node (having an aggregated architecture), meaning that the network node 105 may implement a full radio protocol stack that is physically and logically integrated within a single node (for example, a single physical structure) in the wireless communication network 100. For example, an aggregated network node 105 may consist of a single standalone base station or a single TRP that uses a full radio protocol stack to enable or facilitate communication between a UE 115 and a core network 120 of the wireless communication network 100.

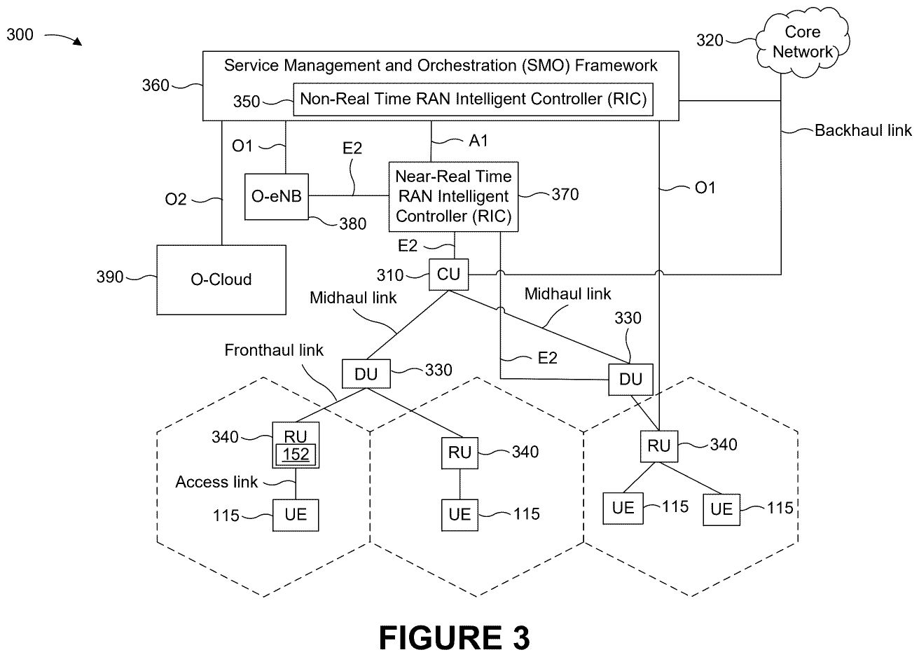

Alternatively, a network node 105 may be a disaggregated network node (sometimes referred to as a disaggregated base station), meaning that the network node 105 may implement a radio protocol stack that is physically distributed and/or logically distributed among two or more nodes in the same geographic location or in different geographic locations. For example, a disaggregated network node may have a disaggregated architecture, as further described herein with reference to FIG. 3. In some deployments, disaggregated network node 105 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 105 of the wireless communication network 100 may include one or more central units (CUs), one or more distributed units (DUs), one or more core networks, and/or one or more radio units (RUs). For example, the core network 120 may be coupled to the network node 105d (e.g., an RU) via fronthaul link 170. A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 115, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 115.

In some aspects, a single network node 105 may include a combination of one or more CUs, one or more DUs, and/or one or more RUs. Additionally, or alternatively, a network node 105 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 105 (for example, a base station, an RU, or a TRP) may provide communication coverage for a particular geographic area. In the 3GPP, the term “cell” can refer to a coverage area of network node 105 or to a network node 105 itself, depending on the context in which the term is used. A network node 105 may support one or multiple (for example, three) cells. In some examples, a network node 105 may provide communication coverage for a macro cell, a pico cell, a femto cell, or another type of cell. A macro cell may cover a relatively large geographic area (for example, several kilometers in radius) and may allow unrestricted access by UEs 115 with service subscriptions. A pico cell may cover a relatively small geographic area and may allow unrestricted access by UEs 115 with service subscriptions. A femto cell may cover a relatively small geographic area (for example, a home) and may allow restricted access by UEs 115 having association with the femto cell (for example, UEs 115 in a closed subscriber group (CSG)). A network node 105 for a macro cell may be referred to as a macro network node. A network node 105 for a pico cell may be referred to as a pico network node. A network node 105 for a femto cell may be referred to as a femto network node or an in-home network node. In some examples, a cell may not necessarily be stationary. For example, the geographic area of the cell may move according to the location of an associated mobile network node 105 (for example, a train, a satellite base station, an unmanned aerial vehicle, or an NTN network node).

The wireless communication network 100 may be a heterogeneous network that includes network nodes 105 of different types, such as macro network nodes, pico network nodes, femto network nodes, relay network nodes, aggregated network nodes, and/or disaggregated network nodes, among other examples. In the example shown in FIG. 1, network nodes 105d and 105e are regular macro network nodes, while network nodes 105a-105c are macro network nodes enabled with one of 3 dimension (3D), full dimension (FD), or massive MIMO. Network nodes 105a-105c take advantage of their higher dimension MIMO capabilities to exploit 3D beamforming in both elevation and azimuth beamforming to increase coverage and capacity. Network node 105f is a small cell network node which may be a home node or portable access point. A network node 105 may support one or multiple cells, such as two cells, three cells, four cells, and the like. Various different types of network nodes 105 may generally transmit at different power levels, serve different coverage areas, and/or have different impacts on interference in the wireless communication network 100 than other types of network nodes 105. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 105 may be, may include, or may operate as an RU, a TRP, or a base station that communicates with one or more UEs 115 via a radio access link (which may be referred to as a “Uu” link). The radio access link may include a downlink and an uplink. “Downlink” (or “DL”) refers to a communication direction from a network node 105 to a UE 115, and “uplink” (or “UL”) refers to a communication direction from a UE 115 to a network node 105. Downlink channels may include one or more control channels and one or more data channels. A downlink control channel may be used to transmit downlink control information (DCI) (for example, scheduling information, reference signals, and/or configuration information) from a network node 105 to a UE 115. A downlink data channel may be used to transmit downlink data (for example, user data associated with a UE 115) from a network node 105 to a UE 115. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 115 to a network node 105. An uplink data channel may be used to transmit uplink data (for example, user data associated with a UE 115) from a UE 115 to a network node 105. Uplink control channels may include one or more physical uplink control channels (PUCCHs), and uplink data channels may include one or more physical uplink shared channels (PUSCHs). The downlink and the uplink may each include a set of resources on which the network node 105 and the UE 115 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 115. A UE 115 may be configured with both an uplink BWP and a downlink BWP (where the uplink BWP and the downlink BWP may be the same BWP or different BWPs). A BWP may be dynamically configured (for example, by a network node 105 transmitting a DCI configuration to the one or more UEs 115) and/or reconfigured, which means that a BWP can be adjusted in real-time (or near-real-time) in accordance with changing network conditions in the wireless communication network 100 and/or in accordance with the specific requirements of the one or more UEs 115. This enables more efficient use of the available frequency domain resources in the wireless communication network 100 because fewer frequency domain resources may be allocated to a BWP for a UE 115 (which may reduce the quantity of frequency domain resources that a UE 115 is required to monitor), leaving more frequency domain resources to be spread across multiple UEs 115. Thus, BWPs may also assist in the implementation of lower-capability UEs 115 by facilitating the configuration of smaller bandwidths for communication by such UEs 115.

As described above, in some aspects, the wireless communication network 100 may be, may include, or may be included in, an IAB network. In an IAB network, at least one network node 105 is an anchor network node that communicates with the core network 120. An anchor network node 105 may also be referred to as an IAB donor (or “IAB-donor”). The anchor network node 105 may connect to the core network 120 via a wired backhaul link. For example, an Ng interface of the anchor network node 105 may terminate at the core network 120. Additionally, or alternatively, an anchor network node 105 may connect to one or more devices of the core network 120 that provide a core access and mobility management function (AMF). An IAB network also generally includes multiple non-anchor network nodes 105, which may also be referred to as relay network nodes or simply as IAB nodes (or “IAB-nodes”). Each non-anchor network node 105 may communicate directly with the anchor network node 105 via a wireless backhaul link to access the core network 120, or may communicate indirectly with the anchor network node 105 via one or more other non-anchor network nodes 105 and associated wireless backhaul links that form a backhaul path to the core network 120. Some anchor network nodes 105 or other non-anchor network nodes 105 may also communicate directly with one or more UEs 115 via wireless access links that carry access traffic. In some examples, network resources for wireless communication (such as time resources, frequency resources, and/or spatial resources) may be shared between access links and backhaul links.

The wireless communication network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

The UEs 115 are physically dispersed throughout the wireless communication network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile phone, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A UE 115 may additionally be an “Internet of Things” (IoT) or “Internet of Everything” (IoE) device, an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples. The UEs 115 may also include digital home or smart home devices, such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless communication network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access the wireless communication network 100.

A mobile apparatus, such as the UEs 115, may be able to communicate with any type of the network nodes, whether macro network nodes, pico network nodes, femto network nodes, macro base stations, pico base stations, femto base stations, relays, and the like. In FIG. 1, a communication link (represented as a lightning bolt) indicates wireless transmissions between a UE and a serving network node, which is a network node designated to serve the UE on the downlink or uplink, wireless transmissions between network nodes, and backhaul transmissions between network nodes. Backhaul communication between network nodes of the wireless communication network 100 may occur using wired or wireless communication links.

In some examples, two or more UEs 115 (for example, shown as UE 115i and UE 115j) may communicate directly with one another using sidelink communications (for example, without communicating by way of a network node 105 as an intermediary). As an example, the UE 115i may directly transmit data, control information, or other signaling as a sidelink communication to the UE 115j. This is in contrast to, for example, the UE 115i first transmitting data in a UL communication to a network node 105, which then transmits the data to the UE 115j in a DL communication. In various examples, the UEs 115 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 105 may schedule and/or allocate resources for sidelink communications between UEs 115 in the wireless communication network 100. In some other deployments and configurations, a UE 115 (instead of a network node 105) may perform, or collaborate or negotiate with one or more other UEs to perform, scheduling operations, resource selection operations, and/or other operations for sidelink communications.

In some examples, the UEs 115 and the network nodes 105 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As an example of operation at the wireless communication network 100, the network nodes 105a-105c serve the UEs 115a and 115b using 3D beamforming and coordinated spatial techniques, such as coordinated multipoint (CoMP) or multi-connectivity. Macro network node 105d performs backhaul communications with the network nodes 105a-105c, as well as with the small cell network node 105f. Macro network node 105d also transmits multicast services which are subscribed to and received by the UEs 115c and 115d. Such multicast services may include mobile television or streaming video, or may include other services for providing community information, such as weather emergencies or alerts, such as Amber alerts or gray alerts.

The wireless communication network 100 of implementations supports mission critical communications with ultra-reliable and redundant links for mission critical devices, such the UE 115e, which is a drone. Redundant communication links with the UE 115e include communication links from the macro network nodes 105d and 105e, as well as the small cell network node 105f. Other machine type devices, such as UE 115f (thermometer), the UE 115g (smart meter), and the UE 115h (wearable device) may communicate through the wireless communication network 100 either directly with network nodes, such as the small cell network node 105f and the macro network node 105e, or in multi-hop configurations by communicating with another user device which relays its information to the network, such as the UE 115f communicating temperature measurement information to the UE 115g, which is then reported to the network through the small cell network node 105f. The wireless communication network 100 may provide additional network efficiency through dynamic, low-latency TDD or FDD communications, such as in a vehicle-to-vehicle (V2V) mesh network between the UEs 115i-115k communicating with the macro network node 105e.

In some aspects, one or more of the network nodes 105 may perform wireless communications that support a discovery procedure associated with a VLAN ID. For example, one or more of the network nodes 105 (such as the network node 105d) may include a communication manager 152 that manages operations that support a discovery procedure associated with a VLAN ID. The operations may include, based on a determination that a signal quality of an Ethernet channel established between a network node 105 and another network device (such as another network node, a DU, a CU, the core network 120, or a server device) satisfies a first threshold, the network node 105 is configured to halt performance of the first instance of the discovery procedure as further described herein with reference to FIG. 4. Additionally, the operations may further include, based on a determination that the signal quality of the Ethernet channel satisfies a second threshold, the network node 105 is configured to perform a second instance of the discovery procedure for the first VLAN ID.

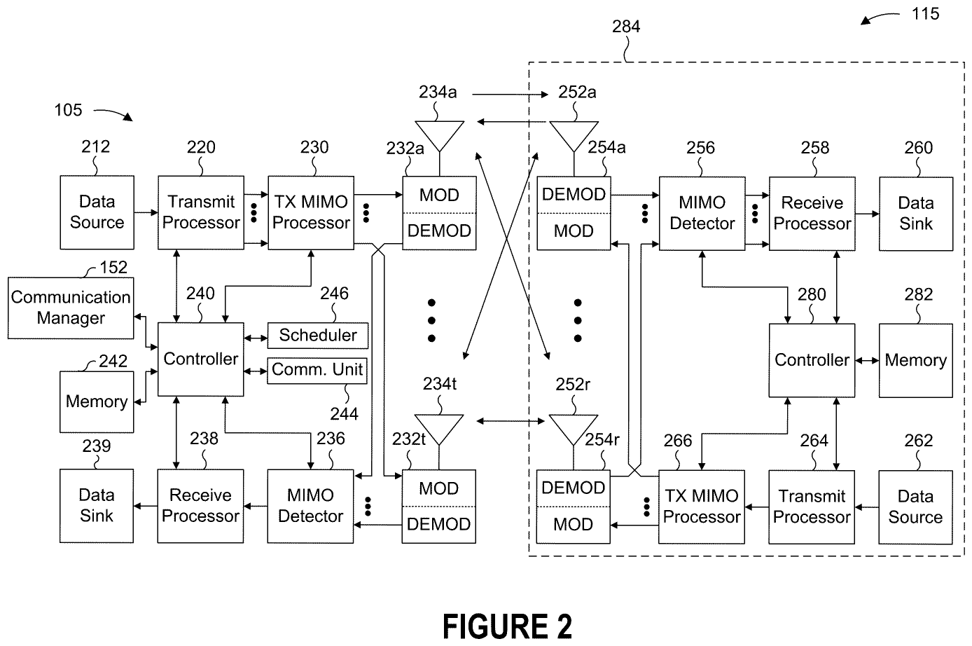

FIG. 2 is a block diagram illustrating examples of a network node 105 and a UE 115 in accordance with the present disclosure. The network node 105 and the UE 115 may be one of the network nodes 105 and one of the UEs 115 in FIG. 1. The network node 105 may be a base station or network entity of some other type. As shown in FIG. 2, the network node 105 may be equipped with antennas 234a through 234t, and the UE 115 may be equipped with antennas 252a through 252r for facilitating wireless communications.

For downlink communication from the network node 105 to the UE 115, a transmit processor 220 may receive data (“downlink data”) from a data source 212 (such as a data pipeline or a data queue) and control information from a controller 240. The control information may be for the physical broadcast channel (PBCH), physical control format indicator channel (PCFICH), physical hybrid-ARQ (automatic repeat request) indicator channel (PHICH), PDCCH, enhanced physical downlink control channel (EPDCCH), or MTC physical downlink control channel (MPDCCH), among other examples. The data may be for the PDSCH, among other examples. The transmit processor 220 may process, such as encode and symbol map, such as in accordance with a selected modulation and coding scheme (MCS), the data and control information to obtain data symbols and control symbols, respectively. Additionally, the transmit processor 220 may generate reference symbols for reference signals, such as for a cell-specific reference signal (CRS), a demodulation reference signal (DMRS), or a channel state information (CSI) reference signal (CSI-RS) and/or synchronization signals, such as for a primary synchronization signal (PSS) or a secondary synchronization signal (SSS).

Transmit (TX) multiple-input multiple-output (MIMO) processor 230 may perform spatial processing on the data symbols, the control symbols, and/or the reference symbols, if applicable, and may provide output symbol streams to modems 232a through 232t. For example, each output symbol stream may be provided to a respective modulator component (shown as MOD) of a modem 232. In some examples, spatial processing performed on the data symbols, the control symbols, and/or the reference symbols may include precoding. Each modem 232 may use the respective modulator component to process a respective output symbol stream, such as for OFDM, among other examples, to obtain an output sample stream. Each modem 232 may additionally, or alternatively use the respective modulator component to process the output sample stream to obtain a downlink signal. For example, to process the output sample stream, each modem 232 may use the respective modulator component to convert to analog, amplify, filter, and upconvert the output sample stream to obtain the downlink signal. The modems 232a through 232t may together transmit a set of downlink signals from via the antennas 234a through 234t, respectively.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

At the UE 115, the antennas 252a through 252r may receive the downlink signals from the network node 105 and may provide a set of received signals to modems 254a through 254r. For example, each received signal may be provided to a respective demodulator component (shown as DEMOD) of a modem 254. Each modem 254 may use the respective demodulator component to condition a respective received signal to obtain input samples. For example, to condition the respective received signal, the demodulator component of each modem 254 may filter, amplify, downconvert, and/or digitize the respective received signal to obtain the input samples. Each modem 254 may use the respective demodulator component to further process the input samples, such as for OFDM, among other examples, to obtain received symbols. MIMO detector 256 may obtain received symbols from modems 254a through 254r, perform MIMO detection on the received symbols if applicable, and provide detected symbols. Receive processor 258 may process the detected symbols, provide decoded data for the UE 115 to a data sink 260 (which may include a data pipeline, a data queue, and/or an application executed on the UE 115), and provide decoded control information to a controller 280. For example, to process the detected symbols, the receive processor 258 may demodulate, deinterleave, and decode the detected symbols.

In some aspects, one or a combination of the antenna(s) 252, the modem(s) 254, the MIMO detector 256, the receive processor 258, the transmit processor 264, or the TX MIMO processor 266 may be included in a transceiver that is included in the UE 115. The transceiver may be under control of and used by one or more processors, such as the controller 280, and in some aspects in conjunction with processor-readable code stored in the memory 282, to perform aspects of the methods, processes, or operations described herein. In some aspects, the UE 115 may include another interface, another communication component, and/or another component that facilitates communication with the network node 105 and/or another UE 115. Additionally, or alternatively, one or more of the components of the UE 115 may be included in a housing 284.

For uplink communications from the UE 115 to the network node 105, a transmit processor 264 may receive and process data (“uplink data”) from a data source 262 and control information (such as for the PUCCH) from the controller 280. The control information may include one or more parameters, feedback, one or more signal measurements, and/or other types of control information. In some aspects, the receive processor 258 and/or the controller 280 may determine, for a received signal (such as received from the network node 105 or another Ue), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 115 by the network node 105.

The transmit processor 264 may generate reference symbols for a reference signal, such as an uplink DMRS, an uplink sounding reference signal (SRS), and/or another type of reference signal. The symbols from the transmit processor 264 may be precoded by a TX MIMO processor 266, if applicable, and further processed by the modems 254a through 254r (such as for DFT-s-OFDM or CP-OFDM, among other examples). The TX MIMO processor 266 may perform spatial processing (for example, precoding) on the data symbols, the control symbols, and/or the reference symbols, if applicable, and may provide a set of output symbol streams to the modems 254. For example, each output symbol stream may be provided to a respective modulator component (shown as MOD) of a modem 254. Each modem 254 may use the respective modulator component to process a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals via the corresponding antennas 252a through 252r, respectively. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 115) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

At network node 105, the uplink signals from the UE 115 may be received by antennas 234a through 234t, processed by demodulator components of the modems 232a through 232t, detected by a MIMO detector 236 if applicable, and further processed by a receive processor 238 to obtain decoded data and/or control information sent by the UE 115. The receive processor 238 may provide the decoded data to a data sink 239 (which may be a data pipeline, a data queue, and/or another type of data sink) and provide the decoded control information to the controller 240.

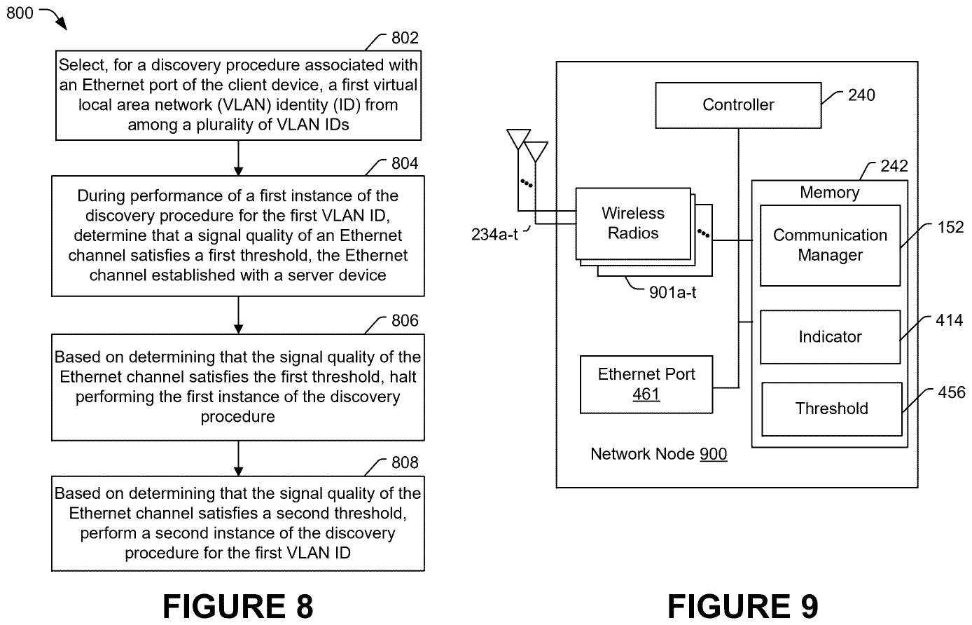

The controllers 240 and 280 may direct the operation at the network node 105 and the UE 115, respectively. The controller 240 (or other processors and modules at the network node 105) may perform or direct the execution of various processes for the techniques described herein, such as to perform or direct the execution illustrated in FIG. 4 or 8, or other processes for the techniques described herein. For example, the controller 240 may perform or control operations that support a discovery procedure associated with a VLAN ID. The discovery procedure, such as a DHCP discovery procedure, may be performed between the network node 105 (e.g., the communication manager 152) and another network device (such as another network node, a DU, a CU, the core network 120, or a server device).

Although referred to as “controllers”, the controllers 240 and 280 may include one or more processors and/or one or more controllers, and also or in the alternative be referred to as “processors” or “controller/processors”. In some aspects, a single processor may perform all of the operations described as being performed by the one or more processors or the one or more controllers. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors.

The memories 242 and 282 may store data and program codes for the network node 105 and the UE 115, respectively. Reference to “one or more memories” should be understood to refer to any one or more memories of a corresponding device, such as the memory described in connection with FIG. 2. For example, an operation described as being performed by one or more memories can be performed by the same subset of the one or more memories or different subsets of the one or more memories.

The network node 105 may use a scheduler 246 to schedule one or more UEs 115 for downlink or uplink communications. In some aspects, the scheduler 246 may use DCI to dynamically schedule DL transmissions to the UE 115 and/or UL transmissions from the UE 115. In some examples, the scheduler 246 may allocate recurring time domain resources and/or frequency domain resources that the UE 115 may use to transmit and/or receive communications using an RRC configuration (for example, a semi-static configuration), for example, to perform semi-persistent scheduling (SPS) or to configure a configured grant (CG) for the UE 115.

In some examples, the network node 105 may use a communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 105 may use the communication unit 244 to transmit and/or receive data associated with the UE 115 or to perform network control signaling, among other examples. The communication unit 244 may include a transceiver and/or an interface, such as a network interface.

One or more antennas of the antennas 252 or the antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 115 or network nodes 105 may include different numbers of antenna elements. For example, a UE 115 may include a single antenna element, two antenna elements, four antenna elements, eight antenna elements, or a different number of antenna elements. As another example, a network node 105 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

FIG. 3 is a block diagram illustrating an example disaggregated base station architecture 300 in accordance with the present disclosure. One or more components of the example disaggregated base station architecture 300 may be, may include, or may be included in one or more network nodes (such as one or more network nodes 105). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some implementations, the core network 320 includes or corresponds to the core network 120 of FIG. 1. In some implementations, the core network 320, the DU 330, or both may include or correspond to a server device (e.g., a server). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 115 via respective RF access links. In some deployments, a UE 115 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

The RUs 340 of FIG. 3 may implement one or more techniques or perform one or more operations associated with a discovery procedure associated with a VLAN ID, as described further herein. For example, RUs 340 may include the communication manager 152, which may manage operations to support a discovery procedure associated with a VLAN ID. Although shown as being included in a single RU 340 in FIG. 3, any of the RUs 340 may include the communication manager 152. The communication manager 152 may direct operations of, for example, one or more operations described with reference to FIG. 4, the process 800 of FIG. 8, or other processes as described herein (alone or in conjunction with one or more other processors).

In some examples, the communication manager 152 may include, or have access to, a non-transitory computer-readable medium storing a set of instructions (for example, code or program code) for wireless communication. The memory may include one or more memories, such as a single memory or multiple different memories (of the same type or of different types). For example, the set of instructions, when executed (for example, directly, or after compiling, converting, or interpreting) by the communication manager 152, one or more processors of the RU 340 may cause the one or more processors or the communication manager 152 to perform, one or more operations described with reference to FIG. 4, the process 800 of FIG. 8, or other processes as described herein. In some examples, executing instructions may include running the instructions, converting the instructions, compiling the instructions, and/or interpreting the instructions, among other examples.

FIG. 4 is a block diagram illustrating an example wireless communication system 400 that supports a discovery procedure associated with a VLAN ID in accordance with the present disclosure. In some examples, the wireless communication system 400 may implement aspects of the wireless communication network 100. The wireless communication system 400 includes the network node 105 and the server device 420 (hereinafter “the server 420”). Although one network node 105 and one server 420 are illustrated, in some other implementations, the wireless communication system 400 may generally include multiple network nodes 105, multiple servers 420, or both. The network node 105 may include or correspond to a first dynamic host configuration protocol (DHCP) device. The server 420 may include or correspond to a second DHCP device. In some embodiments, the network node 105 may include or correspond to an RU (such as the RU 340), and the server 420 may include or correspond to another network node, such as the DU 330, the CU 310, the core network 120 or 320, or the SMO framework 360.

The network node 105 can include a variety of components (such as structural, hardware components) used for carrying out one or more functions described herein. For example, these components can include one or more processors 450 (hereinafter referred to collectively as “the processor 450”), one or more memory devices 452 (hereinafter referred to collectively as “the memory 452”), one or more Ethernet ports 461 (hereinafter referred to collectively as “the Ethernet port 461”), one or more transmitters 462 (hereinafter referred to collectively as “the transmitter 462”), and one or more receivers 464 (hereinafter referred to collectively as “the receiver 464”). Although referred to as a processor 450, the network node 105 may include one or more chips, system-on-chips (SoCs), chipsets, packages, or devices that individually or collectively constitute or include a processing system. The processing system includes processor (or “processing”) circuitry in the form of one or multiple processors (such as the processor 450), microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor 450” or “the processor circuitry”).

One or more of the processors 450 may be individually or collectively configurable or configured to perform various functions or operations described herein. A group of processors, such as the processors 450, collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 450 may be configured to execute code 453, such as one or more instructions, stored in the memory 452 to perform the operations described herein. In some implementations, the processor 450 includes or corresponds to the receive processor 238, the transmit processor 220, the controller 240, or a combination thereof, and the memory 452 includes or corresponds to the memory 242, described with reference to FIG. 2. In some implementations, the processor 450, the memory 452, the code 453, another component of the network node 105, or a combination thereof, may include or correspond to the communication manager 152 of FIGS. 1-3 and/or may perform the operations associated with the communication manager 152 to support a discovery procedure associated with a VLAN ID. In some implementations, a “processing system” includes one or more processors (the processor 450) and one or more memories (the memory 452) that store the code 453 and are coupled with one or more processors. In such embodiments, such a processing system is configured to cause the network node 105 to perform the operations described herein.

The processor 450 includes a discovery engine 410 and a signal quality monitor 412. The discovery engine 410 is configured to perform, for each VLAN ID of a plurality of VLAN IDs, an instance of a discovery procedure over an Ethernet channel, such as Ethernet channel 490 established between the network node 105 and the server 420. The discovery procedure may comport with one or more communication standards, such as an ETSI TS 104 023 standard, an RFC.2131 standard, or a combination thereof.

An instance of the discovery procedure includes, for the VLAN ID, sending one or more messages to the server 420 and receiving and processing one or more messages from the server 420 to determine whether to associate the VLAN ID with an Internet protocol (IP) address. In a completed instance of the discovery procedure, the network node 105 sends a discovery message 470 (e.g., a DHCP discovery message) to the server 420 and receives, based on the sent discovery message 470, an offer message 472 from the server 420. Additionally, in a completed instance of the discovery procedure, in response to receipt of the offer message 472, the network node 105 sends a request message (e.g., a DHCP request message) to the server 420 and receives, from the server 420, an acknowledgement (ACK)/non-acknowledgment (NACK) message (e.g., a DHCP ACK/NACK message) from the server 420. The network node 105 determines whether to associate an IP address with the VLAN ID based on the received ACK/NACK message. For instance, an ACK message includes an IP address and information to configure the same, while a NACK message indicates that the VLAN ID is not to be associated with an IP address. Interruption of the Ethernet channel 490, however, interferes with the sending or receipt of one or more messages of one or more instances of the discovery procedure (e.g., the offer message 472, the request message, or the ACK/NACK message), thereby preventing the discovery engine 410 from determining, for the affected VLAN IDs, whether to associate an IP address with the affected VLAN IDs.

The signal quality monitor 412 is configured to monitor the Ethernet channel 490. For example, to monitor the Ethernet channel 490, the signal quality monitor 412 may be configured to measure the signal quality 455 of the Ethernet channel 490 and to compare the signal quality 455 of the Ethernet channel 490 to one or more thresholds, such as a threshold 456.

The memory 452 may be configured to store the code 453, one or more VLAN IDs 454 (hereinafter referred to collectively as “the VLAN ID 454”), a signal quality 455, and one or more thresholds 456 (hereinafter referred to collectively as “the threshold 456”). The VLAN ID 454 may include or be associated with a range of VLAN ID values (e.g., integer values) from one to four thousand and ninety-four. At least one VLAN of the VLAN ID 454 may correspond to a VLAN over which M-plane communication 474 may occur between the network node 105 and the server 420.

The signal quality 455 may indicate a result of a signal quality measurement performed on the Ethernet channel 490, such as a measurement performed by the signal quality monitor 412. For example, the signal quality 455 may include or indicate a bit error rate associated with the Ethernet channel 490.

The threshold 456 includes or corresponds to a first threshold, a second threshold, or a combination thereof. The first threshold may correspond to a first bit error rate of a first data transmission over the Ethernet channel 490, and the second threshold may correspond to a second bit error rate of a second data transmission over the Ethernet channel 490.

The Ethernet port 461 is configured to facilitate communication with the server 420 over the Ethernet channel 490. For example, the communication may include M-plane communication 474 via which the server 420 may manage one or more functionalities of the network node 105. Such functionalities may include, for instance, updating code 453, adjusting one or more parameters or configurations of the network node 105, or a combination thereof, to facilitate wireless and wired communication between the network node 105 and the server 420.

The transmitter 462 is configured to transmit reference signals, synchronization signals, control information, and data to one or more other devices, and the receiver 464 is configured to receive reference signals, control information and data from one or more other devices. For example, the transmitter 462 may transmit signaling, control information and data to, and the receiver 464 may receive signaling, control information and data from, the server 420. In some implementations, the transmitter 462 and the receiver 464 may be integrated in one or more transceivers. Additionally, or alternatively, the transmitter 462 or the receiver 464 may include or correspond to one or more components of the network node 105 described with reference to FIG. 2.

The server 420 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transmitters 415 (hereinafter referred to collectively as “the transmitter 415”), and one or more receivers 416 (hereinafter referred to collectively as “the receiver 416”). Although referred to as a processor 402, the server 420 may include one or more chips, SoCs, chipsets, packages, or devices that individually or collectively constitute or include a processing system. The processing system includes processor (or “processing”) circuitry in the form of one or multiple processors (such as the processor 402), microprocessors, processing units (such as CPUs, GPUs, NPUs and/or DSPs), processing blocks, ASICs, PLDs (such as FPGAs), or other discrete gate or transistor logic or circuitry (all of which may be generally referred to herein individually as “processors” or collectively as “the processor 402” or “the processor circuitry”).

One or more of the processors 402 may be individually or collectively configurable or configured to perform various functions or operations described herein. A group of processors, such as the processors 402, collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 402 may be configured to execute code 405, such as one or more instructions, stored in the memory 404 to perform the operations described herein. In some implementations, the processor 402, the memory 404, the code 405, another component of the server 420, or a combination thereof, may perform the operations to support a discovery procedure associated with a VLAN ID. In some implementations, a “processing system” includes one or more processors (the processor 402) and one or more memories (the memory 404) that store the code 405 and are coupled with one or more processors. In such embodiments, such a processing system is configured to cause the server 420 to perform the operations described herein.

The memory 404 may be configured to store the code 405 and assigned IP information 406. The assigned IP information 406 may include or correspond to an IP address assigned by server 420 to the network node 105, such as to a VLAN ID associated with a particular VLAN that is assigned or allocated to the Ethernet port 461. Additionally, the assigned IP information 406 may include one or more parameters for the network node 105 to configure the assigned IP address (e.g., to configure the Ethernet port 461).

The transmitter 415 is configured to transmit reference signals, control information and data to one or more other devices, and the receiver 416 is configured to receive reference signals, synchronization signals, control information and data from one or more other devices. For example, the transmitter 415 may transmit signaling, control information and data to, and the receiver 416 may receive signaling, control information and data from, the network node 105. In some implementations, the transmitter 415 and the receiver 416 may be integrated in one or more transceivers.

In some implementations, the wireless communication system 400 is configured to implement a 5G NR network or a 6G network. For example, the wireless communication system 400 may include multiple 5G-capable UEs 115 (or 6G-capable UEs 115) and/or multiple 5G-capable network nodes 105 (or 6G-capable network nodes 105), such as UEs and network nodes configured to operate in accordance with a 5G NR network protocol, or a 6G network protocol, such as that defined by the 3GPP.

During operation of the wireless communication system 400, the network node 105 (e.g., the processor 450) is configured to determine whether the Ethernet port 461 is a trunk port or an access port. For example, the discovery engine 410 may determine whether the Ethernet port 461 is a trunk port or an access port. An Ethernet port that is a trunk port can manage multiple VLANs, while an Ethernet port that is an access port can manage a single VLAN. Accordingly, since a trunk port manages multiple VLANs, data frames are tagged with a VLAN ID to specify the VLAN with which the data frames are associated. In contrast, since an access port manages a single VLAN, data passing through the access port typically is not tagged. In response to a determination that the Ethernet port 461 is an access port, the network node 105 performs an untagged, non-VLAN discovery procedure to acquire an assigned IP address for the Ethernet port 461 that is the access port. Alternatively, in response to a determination that the Ethernet port 461 is a trunk port, the discovery engine 410 is configured to perform, for each VLAN ID, one or more instances of a tagged discovery procedure, such as the discovery procedure as described above.

To perform an instance of the discovery procedure (e.g., a first instance), the processor 450 (e.g., the discovery engine 410) is configured to select a first VLAN ID from the VLAN ID 454. To perform an instance of the discovery procedure, the discovery engine 410 is configured to transmit one or more messages to and/or receive one or more messages from the server 420 via the Ethernet channel 490 to determine whether to associate an IP address with the selected VLAN ID.

The processor 450 (e.g., the signal quality monitor 412) is configured to monitor a signal quality of transmissions over the Ethernet channel 490. For example, the signal quality monitor 412 may periodically or continuously monitor the signal quality of transmissions over the Ethernet channel 490. Additionally, or alternatively, the signal quality monitor 412 may monitor the signal quality of the Ethernet channel 490 at times that coincide with performance of one or more instances of the discovery procedure.

Accordingly, during performance of a first instance of the discovery procedure, the signal quality monitor 412 may detect that the signal quality satisfies a threshold 456 (e.g., is less than or equal to a first threshold value). In some embodiments, the signal quality being less than or equal to the first threshold value may indicate a deteriorated signal quality over the Ethernet channel 490. In response to detecting the signal quality satisfying the threshold 456 (e.g., the first threshold value), the processor 450 (e.g., the discovery engine 410) is configured to halt performance of the first instance of the discovery procedure. For example, the discovery engine 410 may refrain from sending a message that is to be sent as part of the first instance of the discovery procedure, may not process a message received as part of the first instance of the discovery procedure, or both. In particular, to halt the first instance of the discovery procedure, the network node 105 may stop the first instance of the discovery procedure.

Additionally, as part of halting the first instance of the discovery procedure, the processor 450 (e.g., the discovery engine 410) is configured to identify an indicator 414. The indicator indicates or corresponds to the VLAN ID at which the first instance of the discovery procedure is halted. For example, the indicator 414 may be a counter instantiated during performance of the discovery procedure such that, after completion of any instance of the discovery procedure, the network node 105 adjusts (e.g., increments) the value of the counter. If, however, an instance of the discovery process is halted, the network node 105 fails to adjust the value of the counter, thereby indicating a VLAN ID corresponding to the instance of the discovery procedure that was halted. Accordingly, while the discovery is halted, the network node 105 may maintain the value of the counter—e.g., not adjust the value of the counter. Other examples of the indicator 414 include an index that corresponds to the VLAN ID or a pointer indicating an address in memory 452 at which a value that corresponds to the VLAN ID is stored. In some embodiments, to identify the indicator 414, the discovery engine 410 may cause the indicator 414 (e.g., an index, a counter, a pointer, etc.) associated with the VLAN ID (e.g., the first VLAN ID) to be stored in memory 452.

As above, the signal quality monitor 412 may monitor the signal quality on the Ethernet channel 490. Based on these signal quality measurements and the network node 105 may determine that the signal quality of the Ethernet channel satisfies a threshold 456 (e.g., is greater than or equal to a second threshold value). The signal quality satisfying the threshold 456 (e.g., the second threshold value) may indicate that communication is restored or available over the Ethernet channel 490. In response to a determination that the signal quality of the Ethernet channel satisfies the threshold 456 (e.g., is greater than or equal to the second threshold value), the discovery engine 410 is configured to perform a second instance of the discovery procedure for the first VLAN ID. To perform the second instance of the discovery procedure for the first VLAN ID, the discovery engine 410 is configured to obtain the indicator 414. To obtain the indicator 414, the discovery engine 410 is configured to obtain an index stored in memory 452, obtain a value of a counter, or access an address of memory 452 indicated by a pointer and at which a value corresponding to the first VLAN ID is stored.

It is noted that during performing the second instance of the discovery procedure for the first VLAN ID, the signal quality monitor 412 may monitor a signal quality of the Ethernet channel 490. If the signal quality of the Ethernet channel is again detected to be deteriorated, the discovery engine 410 may halt performance of the second instance of the discovery procedure until the signal quality is restored. In response to restoration of the signal quality of the Ethernet channel 490, the discovery engine may perform a third instance of the discovery procedure for the first VLAN ID. Accordingly, multiple (e.g., two or more) instances of the discovery procedure may be consecutively initiated in relation to the same VLAN ID (for the same Ethernet port 461) as a result on the signal quality of the Ethernet channel 490 being unstable.

As a result of performing the second instance of the discovery procedure for the first VLAN ID, the processor 450 may assign an IP address 463 to Ethernet port 461. For example, the processor 450 (e.g., the discovery engine 410) may assign the IP address 463 to the Ethernet port 461 in response to receipt, by the network node 105, of an ACK message. The network node 105 can then transmit an M-plane communication 474 via the Ethernet port 461. Alternatively, as a result of performing the second instance of the discovery procedure for the first VLAN ID, the processor 450 may not assign an IP address 463 to the Ethernet port 461 (e.g., in response to receipt, by the network node 105, of a NACK message). Accordingly, to assign, for at least one VLAN ID, a respective IP address 463 to the Ethernet port 461, the discovery engine 410 may iteratively perform instances of discovery procedures on each VLAN IDs 454 of the plurality of VLAN IDs 454. In response to an IP address 463 being assigned to the Ethernet port 461, the network node 105 may perform M-plane communication 474. Additionally, the network node 105 may communicate with the server 420 (or another network node) via the Ethernet port 461 after the IP address is assigned to the Ethernet port 461.

In some embodiments, the discovery engine 410 is configured to perform the discovery procedure for a second Ethernet port of the plurality of Ethernet ports. To perform the discovery procedure for the second Ethernet port, the discovery engine 410 is configured to determine whether the second Ethernet port is an access port or a trunk port. In response to determining that the second Ethernet port is a trunk port, the discovery engine 410 is configured to perform instances of the discovery procedure for a plurality of VLAN IDs associated with the second Ethernet port. The discovery engine 410 may perform instances of the discovery procedure for the second Ethernet port 461 in parallel with the instances of the discovery procedure performed for the VLAN IDs associated with the first Ethernet port 461.

In response to detected degradation of the signal quality of the Ethernet channel 490 that occurs during any instance of a discovery procedure performed for any VLAN ID on any Ethernet port, the processor 450 (e.g., discovery engine 410) is configured to halt the performance of such an instance of the discovery procedure. In response to detecting improved or restored signal quality, the processor 450 is configured to initiate, for the Ethernet port associated with the discovery procedure, another instance of the discovery procedure for the same VLAN ID based on the indicator 414 that indicates the VLAN ID at which the instance of the discovery procedure was halted.

As described with reference to FIG. 4, the present disclosure provides techniques for supporting a discovery procedure associated with a VLAN ID. In conventional systems, when an instance of a discovery procedure is interrupted (e.g., due to Ethernet channel degradation), the network node 105 performs, for VLAN IDs, instances of the discovery procedure, even though the Ethernet channel degradation prevents the performed instances of the discovery procedure from being completed. When the signal quality of the Ethernet channel is restored, the discovery procedure is restarted from the first VLAN ID, because the client device has no record of the VLAN ID at which the instance of the discovery procedure was interrupted. Since there can be multiple VLAN IDs and since an instance of a discovery procedure may take time complete, Ethernet channel interruption may cause significant delays in completion of the discovery procedure, thereby delaying M-plane communication and subsequent establishment of a communication link between a client device and a server device.

By obtaining (e.g., storing in memory) an indicator corresponding to the particular VLAN ID at which the Ethernet channel degradation occurred while an instance of a discovery procedure was being performed, the network node 105 is configured to initiate a second instance of the discovery procedure from the particular VLAN ID. In this manner, an instance of the discovery procedure can be resumed from the VLAN ID at which an instance of the discovery procedure was halted due to the Ethernet channel degradation. Accordingly, an amount of time to initiate M-plane communication can be reduced when an Ethernet channel degradation occurs as compared with conventional systems. Additionally, by halting performance of instances of the discovery procedure during Ethernet channel degradation, power is conserved, since the network node 105 and the server 420 are not exchanging messages during this time period.

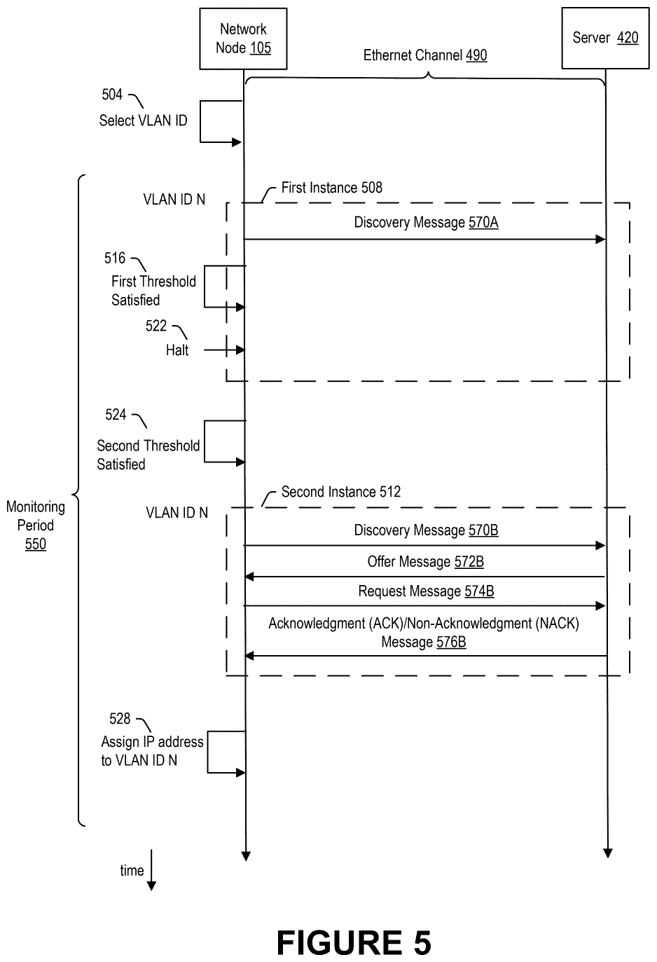

FIGS. 5-7 are ladder diagrams of examples of operations that support a discovery procedure associated with a VLAN ID in accordance with the present disclosure. FIGS. 5-7 depict systems that include the network node 105 (e.g., a DHCP client device), the server 420 (e.g., a DHCP server device), and the Ethernet channel 490. As illustrated in FIGS. 5-7, in response to detection of degradation in a signal quality of an Ethernet channel, a client device stores or maintains a VLAN ID at which an instance of a discovery procedure was being performed. In response to detection that the degradation in signal quality has abated, the client device reinitiates an instance of the discovery procedure from the same VLAN ID.

Referring to FIG. 5, FIG. 5 is a ladder diagram of examples of operations that support a discovery procedure associated with a VLAN ID in accordance with the present disclosure. The network node 105 of FIG. 5 may determine that an Ethernet port from which it is to perform a discovery procedure is a trunk port and not an access port. Accordingly, at 504, the network node 105 selects a VLAN ID, such as the VLAN ID 454 from among a plurality of VLAN IDs 454 that are associated with the Ethernet port 461. For example, the network node 105 may select VLAN ID N (e.g., a first VLAN ID), where N is an integer value greater than or equal to zero, at which to perform a first instance 508 of the discovery procedure. In some embodiments, the plurality of VLAN IDs may include 4,094 VLAN IDs.

Additionally, the network node 105 performs one or more monitoring operations during a monitoring period 550 such that the network node 105 monitors the Ethernet channel 490. To monitor the Ethernet channel 490, the network node 105 may measure the signal quality of the Ethernet channel 490 and may compare the signal quality of the Ethernet channel 490 to one or more thresholds, such as the threshold 456 (e.g., a first threshold, a second threshold, etc.).

As part of performing the first instance 508 of the discovery procedure, the network node 105 sends a discovery message 570A (e.g., a DHCP discovery message, such as the discovery message 470) to the server 420. While monitoring the Ethernet channel 490, the network node 105 may detect an interruption or disturbance in the signal quality of the Ethernet channel 490. For instance, at 516, the network node 105 detects that the signal quality of the Ethernet channel satisfies (e.g., is less than or equal to) a first threshold, which may indicate a degraded signal quality over the Ethernet channel 490.

Based on detection of the interruption or disturbance, the network node 105, at 522, halts performance of the first instance 508 of the discovery procedure. To halt the first instance 508 of the discovery procedure, the network node 105 may identify an indicator, such as the indicator 414, corresponding to the VLAN ID (e.g., VLAN ID N) and stops the performance of the first instance 508 of the discovery procedure. The indicator may, for example, include an index, a counter, a pointer, or other information that corresponds to the VLAN ID. To identify the indicator corresponding to the VLAN ID, the network node 105 may store the index in the one or more memories (e.g., memory 452), maintain a value of the counter, or access an address of the one or more memories indicated by the pointer and at which a value corresponding to the VLAN ID is stored.

At 524, the network node 105 detects that the Ethernet channel signal quality has been restored. For instance, the network node 105 may measure the signal quality of the Ethernet channel 490, compare the signal quality of the Ethernet channel 490 to one or more thresholds (e.g., a second threshold), and determine, based on the comparison, that the second threshold has been satisfied (e.g., that the measured signal quality equals or is greater than the second threshold). In some implementations, the first threshold and the second threshold are the same threshold, while in other implementations, they may be different. For example, a value of a second threshold may be greater than a value of the first threshold.

Based on a determination that the signal quality of the Ethernet channel 490 satisfies the second threshold, the network node 105 performs a second instance 512 of the discovery procedure for VLAN ID N. To perform the second instance of the discovery procedure for the VLAN ID N, the network node 105 obtains the indicator corresponding to the VLAN ID N. For example, to obtain the indicator, the network node 105 may retrieve the index stored in the one or more memories, obtaining a value of the counter, or accessing an address of the one or more memories indicated by the pointer and at which a value corresponding to the VLAN ID is stored.

To perform the second instance 512 of the discovery procedure, the network node 105 sends a discovery message 570B (e.g., a DHCP discovery message) to the server 420. Additionally, as part of the discovery procedure, the network node 105 receives an offer message 572B (e.g., a DHCP offer message, such as the offer message 472) from the server 420 in response to the discovery message 570B. In response to receipt of the offer message 572B, the network node 105 sends a request message 574B (e.g., a DHCP request message) to the server 420. In response to the request message 574B, the network node 105 receives an ACK/NACK message 576B (e.g., a DHCP ACK/NACK message) from the server 420. The network node 105 determines whether to associate an IP address with a respective VLAN ID of the plurality of VLAN IDs based on the received ACK/NACK message 576B.

To illustrate, the ACK/NACK message 576B may be a DHCP ACK message or a DHCP NACK message. If the ACK/NACK message 576B is a DHCP ACK message, the network node 105 may identify the IP address indicated in the DHCP ACK message. Additionally, the network node 105 may determine whether the IP address is in use. If the IP address is not in use, the network node 105 may, at 528, assign the identified IP address to VLAN ID N that is associated with the Nth VLAN. Additionally, the network node 105 may initiate, via the Nth VLAN, M-plane communication, such as the M-plane communication 474. If the IP address indicated by the DHCP ACK message is in use, the network node 105 may select another VLAN ID (e.g., a next sequential VLAN ID, such as VLAN ID N+1) for which to perform an instance of the discovery procedure. Alternatively, if the ACK/NACK message 576B is a DHCP NACK message, then the network node 105 may initiate another instance of the discovery procedure for another VLAN ID (e.g., a next sequential VLAN ID, such as VLAN ID N+1) of the plurality of VLAN IDs.

If the network node 105 does not receive an ACK/NACK message 576B, the network node 105 may initiate a retransmission procedure in which the network node 105 retransmits the request message (e.g., request message 574B). In some embodiments, the network node 105 may retransmit the request message one or more times. If, after retransmitting the request message one or more times, the network node 105 fails to receive an ACK/NACK message 576B, the network node 105 may perform another instance of the discovery procedure for the same VLAN ID. Alternatively, if the network node 105 does not receive a response after retransmitting the request message (e.g., one or more times), then the network node 105 may proceed as specified in the ETSI TS 104 023 standard, the RFC.2131 standard, or a combination thereof. In some embodiments, if the signal quality of the Ethernet channel 490 remains greater than or equal to the first threshold); yet, the network node 105 fails to receive an ACK/NACK message 576B in response to a transmitted request message, the network node 105 may retransmit the request message a number of times equal to a request transmission threshold. If, after retransmitting the request message the threshold number of times, the network node 105 fails to receive an ACK/NACK message, then, in some embodiments, the network node 105 may perform an instance of the discovery procedure from the next VLAN ID.

It is understood that, while FIG. 5 describes that the first instance 508 of the discovery procedure is halted in response to detection of degradation of signal quality on the Ethernet channel 490, other instances of the discovery procedure may be halted. For instance, if the network node 105 were to detect a degradation in the signal quality on the Ethernet channel 490, the network node 105 may halt the second instance 512 of the discovery procedure in a similar manner as described with reference to the first instance 508 of the discovery procedure. Additionally, while FIG. 5 describes performing instances of the discovery procedure for a first Ethernet port, similar operations as described with reference to FIG. 5 could be performed for a second Ethernet port serially or in parallel with the procedure being performed for the first Ethernet port.

The techniques described with reference to FIG. 5 provide several technical advantages. For example, as compared to conventional techniques in which a network node (e.g., a client device) continues performing instances of the discovery procedure for additional VLAN IDs when the Ethernet channel is degraded, the disclosed techniques advantageously stops performing instances of the discovery procedure in response to detection of the Ethernet channel degradation, thereby conserving power and ultimately reducing the time to perform the discovery procedure over the plurality of VLAN IDs. Accordingly, the network node 105 advantageously resumes performing an instance of the discovery procedure from stored VLAN ID (e.g., VLAN ID N), thereby avoiding the disadvantage of conventional techniques in which, after an Ethernet channel interruption, the client device begins performing an instance of the discovery procedure from the first VLAN ID in an ordered series of VLAN IDs. Thus, the disclosed techniques reduces the amount of time expended to initiate M-plane communication with the server 420, thereby enhancing communication efficiency among devices of a communication network.

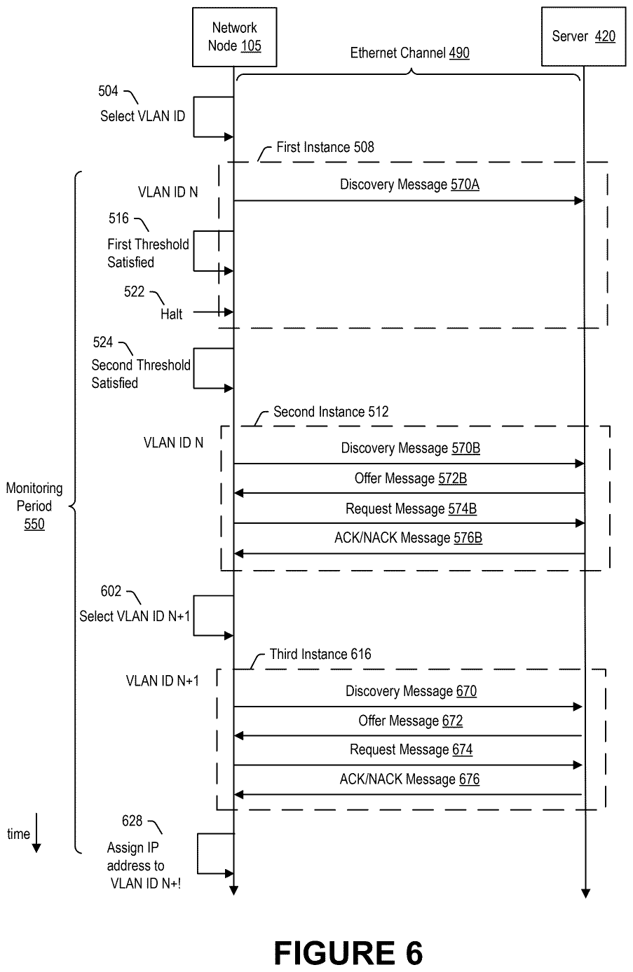

FIG. 6 is a ladder diagram of examples of operations that support a discovery procedure associated with a VLAN ID in accordance with the present disclosure. One or more operations as described with reference to FIG. 6 are the same as one or more operations described above with reference to FIG. 5.

In contrast to FIG. 5, in FIG. 6, after completion of the second instance 512 of the discovery procedure, the network node 105 selects another VLAN ID on which to perform a third instance 616 of the discovery procedure. For example, the ACK/NACK message 576B may be a DHCP NACK message. As another example, the ACK/NACK message 576B may be a DHCP ACK message, but the network node 105 may determine that the IP address, such as the IP address 463, identified in the DHCP ACK message is in use.

Accordingly, at 602, the network node 105 selects VLAN ID N+1, associated with the N+1th VLAN, on which to perform a third instance 616 of the discovery procedure. To perform the third instance 616 of the discovery procedure, the network node 105 sends a discovery message 670 to the server 420, receives an offer message 672 from the server 420, sends a request message 674 to the server 420, and receives an ACK/NACK message 676 from the server 420. In some embodiments, the messages 670-676 may include DHCP messages. After completing the third instance 616 of the discovery procedure and based on IP address information included in ACK/NACK message 676 (e.g., a DHCP ACK message), at 628, the network node 105 assigns an IP address to VLAN ID N+1.

It is understood that, if, during performance of the third instance 616 of the discovery procedure, the network node 105 detects degradation in the signal quality of the Ethernet channel 490, the network node 105 may halt the third instance 616 of the discovery procedure. For example, after receipt of the offer message 672 and in response to detection of degraded signal quality on the Ethernet channel 490, the network node 105 may refrain from transmitting the request message 674. In response to detecting that the signal quality of the Ethernet channel 490 is restored, the network node 105 may initiate a fourth instance of the discovery procedure for VLAN ID N+1 based on an indicator, such as the indicator 414. Additionally, while FIG. 6 shows that an IP address is assigned to VLAN ID N+1 due to, for example, receipt of DHCP ACK message, if the network node 105 instead received a NACK message, the network node 105 could initiate another instance of the discovery procedure for VLAN ID N+2.

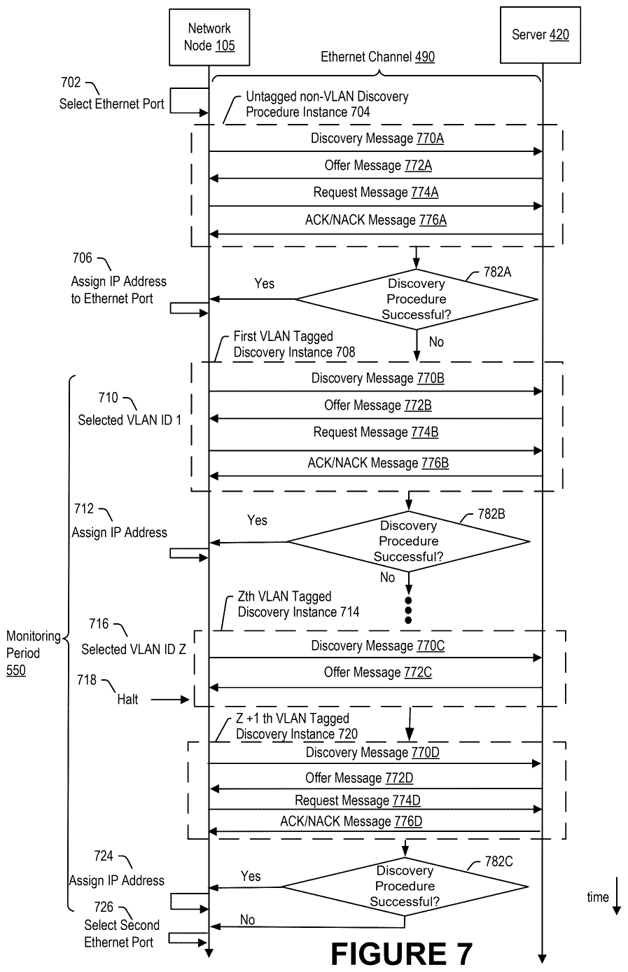

FIG. 7 is a ladder diagram of examples of operations that support a discovery procedure associated with a VLAN ID in accordance with the present disclosure. At 702, the network node 105 selects an Ethernet port (e.g., the Ethernet port 461) from which to perform a discovery procedure.

At 704, the network node 105 performs an untagged non-VLAN discovery procedure instance in which a discovery message 770A, an offer message 772A, a request message 774A, and an ACK/NACK message 776A are exchanged between the network node 105 and the server 420 as part of the untagged non-VLAN discovery procedure. In implementations, the exchanged messages are DHCP messages.

At 782A, the network node 105 determines whether the untagged non-VLAN discovery procedure instance is successful. The network node 105 may determine whether the untagged non-VLAN discovery procedure instance 704 is successful based, for example, on whether the network node 105 receives, from the server 420, an ACK message 776A that includes IP address configuration information. If the instance of the discovery procedure is successful, an IP address is assigned (e.g., by server 420) to the selected Ethernet port. Otherwise, the network node 105 determines that the Ethernet port is a trunk port. Accordingly, the network node 105 performs instances of a discovery procedure for VLAN IDs selected from among a plurality of VLAN IDs.

Additionally, the network node 105 performs one or more monitoring operations during a monitoring period 550 such that the network node 105 monitors the Ethernet channel 490. To monitor the Ethernet channel 490, the network node 105 may measure the signal quality of the Ethernet channel 490 and may compare the signal quality of the Ethernet channel 490 to one or more thresholds (e.g., a first threshold, a second threshold, etc.).

At 710, the network node 105 selects a first VLAN ID 1, and performs a first VLAN tagged discovery instance 708 for the first VLAN ID 1. To perform the first VLAN tagged discovery instance 708, the network node 105 sends a discovery message 770B to the server 420, receives an offer message 772B from the server 420, sends a request message 774B to the server 420, and receives an ACK/NACK message 776B from the server 420. The first tagged VLAN discovery instance 708 may correspond to the first instance 508 of the discovery procedure described with reference to FIG. 5. Accordingly, messages 770B-776B may include or correspond to messages 570B-576B of FIGS. 5 and 6.

At 782B, the network node 105 determines whether the first VLAN tagged discovery instance 708 is successful. To be successful, the network node 105 receives an ACK/NACK message 776 (e.g., a DHCP ACK message) that includes IP address configuration information. An instance of a discovery procedure may, however, be unsuccessful for one or more reasons. For example, as described with reference to FIG. 5, the Ethernet channel 490 may experience signal quality degradation during performance of an instance of the discovery procedure such that the discovery procedure cannot be completed (e.g., the network node 105 fails to send or receive at least one of the offer message 772, the request message 774, or the ACK/NACK message 776). In response to a degraded signal quality over the Ethernet channel 490, the network node 105 performs the operations described with reference to FIGS. 4 and 5 (e.g., halts the performance of the instance of the discovery procedure, etc.). As another example, an instance of a discovery procedure may be unsuccessful, because the network node 105 receives a NACK or an ACK with IP address configuration information for an IP address that is in use.

If the first VLAN tagged discovery instance 708 is successful, at 712, the server 420 assigns an IP address to the Ethernet port. The network node 105 may then iteratively select one or more other VLAN IDs from among the plurality of VLAN IDs to perform other instances of the discovery procedure. Otherwise, if the VLAN tagged discovery instance 708 is unsuccessful because the network node 105 receives a NACK or an ACK with IP address that is in use, the network node 105 iteratively selects other VLAN IDs from among the plurality of VLAN IDs to perform other instances of the discovery procedure.

At 716, the network node 105 has iterated through all but the Zth VLAN ID of the plurality of VLAN IDs, where Z is the total number of VLAN IDs in the plurality of VLAN IDs. The Zth VLAN ID may correspond, for instance, to a last VLAN ID (e.g., a VLAN ID 4,094).

The network node 105 performs the Zth VLAN tagged discovery instance 714 for VLAN ID Z. To perform the Zth VLAN tagged discovery instance 714, the network node 105 sends a discovery message 770C to the server 420, and receives an offer message 772C from the server 420. At 718, however, the network node 105 halts the Zth VLAN tagged discovery instance 714, because, for example, the network node 105 detects that the signal quality of the Ethernet channel 490 satisfies a first threshold (e.g., is equal to or less than the threshold), indicating degraded signal quality. In response to detecting that the signal quality satisfies a second threshold (e.g., is equal to or greater than the threshold), indicating restored signal quality, the network node 105 performs an Z+1th VLAN tagged discovery instance 720 for VLAN ID Z. Accordingly, to perform the Z+1th VLAN tagged discovery instance 720, the network node 105 sends messages 770D and 774D to the server 420 and receives messages 772D and 776D from the server 420. These messages correspond to the messages 570B-576D and 670-676 described with reference to FIGS. 5 and 6.

It is understood that others of the VLAN tagged discovery instances (e.g., the Z−1th VLAN tagged discovery instance, etc.) also may have been halted in like manner in response to detection of signal degradation on the Ethernet channel 490 when those instances of the VLAN tagged discovery instance were being performed. Additionally, while the Zth VLAN tagged discovery instance 714 is depicted as having been halted due to detected signal degradation on the Ethernet channel 490, in other embodiments, the network node 105 may not have halted the Zth VLAN tagged discovery instance 714.

At 782C, the network node 105 determines whether the Z+1th VLAN tagged discovery instance 720 is successful by making one or more of the same determinations as described with reference to 782B. If the discovery procedure is successful, at 724, the network node 105 assigns the IP address indicated in the ACK/NACK message 776D to the Ethernet port. Otherwise, at 726, the network node 105 selects a second Ethernet port from which to perform an untagged non-VLAN discovery procedure instance and possibly VLAN tagged discovery instances (e.g., if the second Ethernet port is a trunk port), proceeding, for the second Ethernet port as the network node 105 proceeded for the first Ethernet port. Although the second Ethernet port is depicted as being selected in time after the first Ethernet port, in other implementations, the discovery procedures for each of the Ethernet ports may be performed concurrently rather than serially.

FIG. 8 is a flow diagram illustrating an example process 800 that supports a discovery procedure associated with a VLAN ID in accordance with the present disclosure. Operations of the process 800 may be performed by the network node 105 described above with reference to FIGS. 1-7. For example, example operations (also referred to as “blocks”) of the process 800 may enable the network node 105 to perform a discovery procedure associated with a VLAN ID, according to some aspects of the present disclosure.

FIG. 9 is a block diagram of an example network node 900 that supports a discovery procedure associated with a VLAN ID in accordance with the present disclosure. The network node 900 may be configured to perform operations, including the blocks of the process 800 described with reference to FIG. 8, to perform a discovery procedure associated with a VLAN ID. In some implementations, the network node 900 includes the structure, hardware, and components shown and described with reference to the network node 105 of FIGS. 1-7. For example, the network node 900 includes the controller 240, which operates to execute logic or computer instructions stored in the memory 242, as well as controlling the components of the network node 900 that provide the features and functionality of the network node 900. The network node 900, under control of the controller 240, transmits and receives signals via wireless radios 901a-t and the antennas 234a-t. The wireless radios 901a-t include various components and hardware, as illustrated in FIG. 2 for the network node 105, including the modems 232 a-t, the MIMO detector 236, the receive processor 238, the transmit processor 220, and the TX MIMO processor 230. Additionally, the network node 900 includes an Ethernet port, such as the Ethernet port 461.

As shown, the memory 242 may include the communication manager 152, the indicator 414, and the threshold 456. Although illustrated in FIG. 9 as being included in the memory 242, in other implementations, the communication manager 152 may be a separate component of the network node 900. The communication manager 152 may be configured to manage one or more operations supporting a discovery procedure associated with a VLAN ID. The network node 900 may receive signals from or transmit signals to one or more other network nodes, such as another network node, a DU 330, a CU 310, the core network 120, or a server 420.

Referring back to the process 800 of FIG. 8, in block 802, the network node 900 selects, for a discovery procedure associated with an Ethernet port of the network node 900, a first VLAN ID from among a plurality of VLAN IDs. For example, the Ethernet port may include or correspond to the Ethernet port 461, and the first VLAN ID and the plurality of VLAN IDs may include or correspond to the VLAN ID 454.

In block 804, the network node 900, during performance of a first instance of the discovery procedure for the first VLAN ID, determines that a signal quality of an Ethernet channel satisfies a first threshold. For example, the Ethernet channel may include or correspond to the Ethernet channel 490, the signal quality may include or correspond to the signal quality 455, and the first threshold may include or correspond to the threshold 456.

The Ethernet channel may be established with a server device, such as the server 420. In some implementations, the client device includes a first DHCP device, and the server device includes a second DHCP device. For example, network node 105 may include or correspond to a DHCP device, and server 420 may include or correspond to a DHCP device.

In block 806, the network node 900, based on determining that the signal quality of the Ethernet channel satisfies the first threshold, halts performing the first instance of the discovery procedure. In some implementations, halting performance of the first instance includes identifying an indicator corresponding to the first VLAN ID and stopping the performance of the first instance of the discovery procedure. For example, the indicator may include or correspond to the indicator 414. In some implementations, the indicator includes an index, a counter, or a pointer. To halt performance of the first instance of the discovery procedure, the network node 900 may identify the indicator corresponding to the first VLAN ID, and stop the performance of the first instance of the discovery procedure. In some examples, to identify the indicator, the network node 900 may store the index in a memory, maintain a value of the counter, or maintain a pointer at which a value corresponding to the first VLAN ID is stored.

In block 808, the network node 900, based on determining that the signal quality of the Ethernet channel satisfies a second threshold, performs a second instance of the discovery procedure for the first VLAN ID. For example, the second threshold may include or correspond to the threshold 456.

In some implementations, performing the second instance of the discovery procedure for the first VLAN ID includes obtaining the indicator corresponding to the first VLAN ID. For example, obtaining the indicator may include retrieving the index stored in the one or more memories, obtaining a value of the counter, or accessing the address of the one or more memories indicated by the pointer and at which the value corresponding to the first VLAN ID is stored. Additionally, or alternatively, in some implementations, performing the second instance of the discovery procedure includes determining, based on the performance of the second instance of the discovery procedure, whether to associate an IP address with the first VLAN ID. The IP address may include or correspond to the IP address 463. To illustrate, performing the discovery procedure includes sending a discovery message to the server device, receiving an offer message from the server device in response to sending the discovery message, sending a request message to the server device in response to receiving the offer message. For example, the discovery message and the offer message may include or correspond to the discovery message 470 (e.g., a DHCP discovery message) and the offer message 472 (e.g., a DHCP offer message), respectively. The process 800 also may include, in response to receiving an acknowledgement (ACK) message from the server device during the performance of the second instance of the discovery procedure, associating the IP address with the first VLAN ID. For example, the process 800 may include determining whether to associate an IP address with a respective VLAN ID based on an ACK message received from the server device in response to sending the request message. In some such implementations, the process 800 also includes associating a first IP address with the first VLAN ID based on performing the second instance of the discovery procedure, performing M-plane communication with the server device via a VLAN corresponding to the first VLAN ID, and establishing communication with the server device in response to the performance of the M-plane communication. For example, the M-plane communication may include or correspond to M-plane communication 474.

In some implementations, the process 800 also includes monitoring the Ethernet channel. The signal quality of the Ethernet channel may include a bit error rate, and the first threshold may correspond to a first bit error rate of a first data transmission over the Ethernet channel, and the second threshold may correspond to a second bit error rate of a second data transmission over the Ethernet channel. In some such implementations, process 800 also includes measuring the signal quality of the Ethernet channel, and comparing the signal quality of the Ethernet channel to one or more thresholds. The one or more thresholds include the first threshold, the second threshold, or a combination thereof.

In some implementations, the process 800 also includes determining whether the Ethernet port is a trunk port or an access port. Additionally, or alternatively, selecting the first VLAN ID may include selecting the first VLAN ID in response to a determination that the Ethernet port is a trunk port.

In some implementations, the network node includes a plurality of Ethernet ports, the plurality of VLAN IDs include a range of VLAN ID values from one to four thousand and ninety-four, and the discovery procedure comports with an ETSI TS 104 023 standard, an RFC.2131 standard, or a combination thereof. The process 800 also may include performing the discovery procedure for a second Ethernet port of the plurality of Ethernet ports. Performing the discovery procedure for the second Ethernet port can include performing a third instance of the discovery procedure.

It is noted that one or more blocks (or operations) described with reference to FIG. 8 may be combined with one or more blocks (or operations) described with reference to another of the figures. For example, one or more blocks (or operations) of FIG. 8 may be combined with one or more blocks (or operations) of FIGS. 5-7. As another example, one or more blocks associated with FIG. 6 or 8 may be combined with one or more blocks (or operations) associated with FIGS. 1-5. Additionally, or alternatively, one or more operations described above with reference to FIGS. 1-8 may be combined with one or more operations described with reference to FIG. 9.

In the following, further examples are described to facilitate the understanding of the disclosure.

According to Example 1, a device includes a processing system coupled to a plurality of Ethernet ports, the processing system including one or more processors and one or more memories coupled to the one or more processors, the processing system configured to select, for a discovery procedure associated with an Ethernet port of the plurality of Ethernet ports, a first virtual local area network (VLAN) identity (ID) from among a plurality of VLAN IDs; during performance of a first instance of the discovery procedure for the first VLAN ID, detect that a signal quality of an Ethernet channel satisfies a first threshold, the Ethernet channel established with a server device; based on a determination that the signal quality of the Ethernet channel satisfies the first threshold, halt the performance of the first instance of the discovery procedure; and based on a determination that the signal quality of the Ethernet channel satisfies a second threshold, perform a second instance of the discovery procedure for the first VLAN ID.

Example 2 includes the device of Example 1, where, to halt the performance of the first instance, the processing system is configured to identify an indicator corresponding to the first VLAN ID; and stop the performance of the first instance of the discovery procedure.

Example 3 includes the device of Example 1 or Example 2, where: the indicator includes an index, a counter, or a pointer, and to identify the indicator, the processing system is configured to store the index in the one or more memories, increment a value of the counter and store the value in the one or more memories, or access an address of the one or more memories indicated by the pointer and at which a value corresponding to the first VLAN ID is stored.

Example 4 includes the device of Example 3, where, to perform the second instance of the discovery procedure for the first VLAN ID, the processing system is configured to obtain the indicator corresponding to the first VLAN ID.

Example 5 includes the device of Example 4, where, to obtain the indicator, the processing system is configured to retrieve the index stored in the one or more memories, retrieve a value of the counter stored in the one or more memories, or access the address of the one or more memories indicated by the pointer and at which the value corresponding to the first VLAN ID is stored.

Example 6 includes the device of any of Examples 1 to 5, where, to perform the discovery procedure, the processing system is configured to send a discovery message to the server device; receive an offer message from the server device in response to the sent discovery message; send a request message to the server device in response to receipt of the offer message; and determine whether to associate an Internet Protocol (IP) address with a respective VLAN ID of the plurality of VLAN IDs based on an acknowledgment (ACK) received from the server device in response to the sent request message.

Example 7 includes the device of Example 6, where the processing system is further configured to associate a first IP address with the first VLAN ID based on performance of the second instance of the discovery procedure.

Example 8 includes the device of any of Examples 1 to 7, where the processing system is further configured to monitor the Ethernet channel, and to monitor the Ethernet channel, the processing system is configured to measure the signal quality of the Ethernet channel; and compare the signal quality of the Ethernet channel to one or more thresholds, the one or more thresholds including the first threshold, the second threshold, or a combination thereof.

Example 9 includes the device of any of Examples 1 to 8, where: the signal quality of the Ethernet channel includes a bit error rate, the first threshold corresponds to a first bit error rate of a first data transmission over the Ethernet channel, and the second threshold corresponds to a second bit error rate of a second data transmission over the Ethernet channel.

Example 10 includes the device of any of Examples 1 to 9, where: the processing system is further configured to determine whether the Ethernet port is a trunk port or an access port, and to select the first VLAN ID, the processing system is configured to select the first VLAN ID in response to a determination that the Ethernet port is a trunk port.

Example 11 includes the device of any of Examples 1 to 10, where the device includes a first dynamic host configuration protocol (DHCP) device, and the server device includes a second DHCP device.

Example 12 includes the device of any of Examples 1 to 11, where, to perform the second instance of the discovery procedure, the processing system is configured to determine, based on the performance of the second instance of the discovery procedure, whether to associate an internet protocol (IP) address with the first VLAN ID.

Example 13 includes the device of Example 12, where the processing system is further configured to, in response to receipt of an acknowledgement message from the server device during the performance of the second instance of the discovery procedure, associate the IP address with the first VLAN ID; perform management (M)-plane communication with the server device via a VLAN corresponding to the first VLAN ID; and establish communication with the server device in response to the performance of the M-plane communication.

Example 14 includes the device of any of Examples 1 to 13, and further includes the plurality of Ethernet ports, where the plurality of VLAN IDs include a range of VLAN ID values from one to four thousand and ninety-four, and where the discovery procedure comports with an ETSI TS 104 023 standard, an RFC.2131 standard, or a combination thereof.

Example 15 includes the device of any of Examples 1 to 14, where: the processing system is further configured to perform the discovery procedure for a second Ethernet port of the plurality of Ethernet ports, and to perform the discovery procedure for the second Ethernet port, the processing system is configured to perform a third instance of the discovery procedure, the third instance performed concurrently with the second instance.

Example 16 includes the device of any of Examples 1 to 15, where the processing system is further configured to measure the signal quality of the Ethernet channel; and compare the signal quality of the Ethernet channel to one or more thresholds, the one or more thresholds including the first threshold, the second threshold, or a combination thereof.

According to Example 17, a method performed by a client device, the method includes selecting, for a discovery procedure associated with an Ethernet port of the client device, a first VLAN ID from among a plurality of VLAN IDs; during performance of a first instance of the discovery procedure for the first VLAN ID, determining that a signal quality of an Ethernet channel satisfies a first threshold, the Ethernet channel established with a server device; based on determining that the signal quality of the Ethernet channel satisfies the first threshold, halting performing the first instance of the discovery procedure; and based on determining that the signal quality of the Ethernet channel satisfies a second threshold, performing a second instance of the discovery procedure for the first VLAN ID.

Example 18 includes the method of Example 17, where halting performing the first instance includes: identifying an indicator corresponding to the first VLAN ID; and stopping performing the first instance of the discovery procedure.

Example 19 includes the method of Example 17 or Example 18, where: the indicator includes an index, a counter, or a pointer, and identifying the indicator includes: storing the index in one or more memories, incrementing a value of the counter and store the value in the one or more memories, or accessing an address of the one or more memories indicated by the pointer and at which a value corresponding to the first VLAN ID is stored.

Example 20 includes the method of Example 19, where performing the second instance of the discovery procedure for the first VLAN ID includes obtaining the indicator corresponding to the first VLAN ID.

Example 21 includes the method of Example 20, where obtaining the indicator includes: retrieving the index stored in the one or more memories, retrieving a value of the counter stored in the one or more memories, or accessing the address of the one or more memories indicated by the pointer and at which the value corresponding to the first VLAN ID is stored.

Example 22 includes the method of any of Examples 17 to 21, where performing the discovery procedure includes: sending a discovery message to the server device; receiving an offer message from the server device in response to sending the discovery message; sending a request message to the server device in response to receiving the offer message; and determining whether to associate an IP address with a respective VLAN ID based on an ACK message received from the server device in response to sending the request message.

Example 23 includes the method of Example 22, and further includes associating a first IP address with the first VLAN ID based on performing the second instance of the discovery procedure.

Example 24 includes the method of any of Examples 17 to 23, and further includes monitoring the Ethernet channel, where monitoring the Ethernet channel includes: measuring the signal quality of the Ethernet channel; and comparing the signal quality of the Ethernet channel to one or more thresholds, the one or more thresholds including the first threshold, the second threshold, or a combination thereof.

Example 25 includes the method of any of Examples 17 to 24, where: the signal quality of the Ethernet channel includes a bit error rate, the first threshold corresponds to a first bit error rate of a first data transmission over the Ethernet channel, and the second threshold corresponds to a second bit error rate of a second data transmission over the Ethernet channel.

Example 26 includes the method of any of Examples 17 to 25, and further includes determining whether the Ethernet port is a trunk port or an access port, and where selecting the first VLAN ID includes selecting the first VLAN ID in response to a determination that the Ethernet port is a trunk port.

Example 27 includes the method of any of Examples 17 to 26, where the client device includes a first DHCP device, and the server device includes a second DHCP device.

Example 28 includes the method of any of Examples 17 to 27, where performing the second instance of the discovery procedure includes determining, based on the performance of the second instance of the discovery procedure, whether to associate an IP address with the first VLAN ID.

Example 29 includes the method of Example 28, and further includes in response to receiving an acknowledgement message from the server device during the performance of the second instance of the discovery procedure, associating the IP address with the first VLAN ID; performing M-plane communication with the server device via a VLAN corresponding to the first VLAN ID; and establishing communication with the server device in response to the performance of the M-plane communication.

Example 30 includes the method of any of Examples 17 to 29, where: the client device includes a plurality of Ethernet ports, the plurality of VLAN IDs include a range of VLAN ID values from one to four thousand and ninety-four, and the discovery procedure comports with an ETSI TS 104 023 standard, an RFC.2131 standard, or a combination thereof.

Example 31 includes the method of Example 30, and further includes performing the discovery procedure for a second Ethernet port of the plurality of Ethernet ports, where performing the discovery procedure for the second Ethernet port includes performing a third instance of the discovery procedure, the third instance performed concurrently with the second instance.

Example 32 includes the method of any of Examples 17 to 31, and further includes measuring the signal quality of the Ethernet channel; and comparing the signal quality of the Ethernet channel to one or more thresholds, the one or more thresholds including the first threshold, the second threshold, or a combination thereof.

According to Example 33, a non-transitory computer-readable medium storing instructions that are executable by one or more processors to cause the one or more processors to perform operations, the operations including: selecting, for a discovery procedure associated with an Ethernet port, a first VLAN ID from among a plurality of VLAN IDs; during performance of a first instance of the discovery procedure for the first VLAN ID, detecting that a signal quality of an Ethernet channel satisfies a first threshold, the Ethernet channel established with a server device; based on detecting that the signal quality of the Ethernet channel satisfies the first threshold, halting performance of the first instance of the discovery procedure; and based on detecting that the signal quality of the Ethernet channel satisfies a second threshold performing a second instance of the discovery procedure for the first VLAN ID.

Example 34 includes the non-transitory computer-readable medium of Example 33, where, to halt the performance of the first instance, the operations include: identifying an indicator corresponding to the first VLAN ID; and stopping the performance of the first instance of the discovery procedure.

Example 35 includes the non-transitory computer-readable medium of Example 33 or Example 34, where: the indicator includes an index, a counter, or a pointer, and to identify the indicator, the operations include: storing the index in one or more memories, incrementing a value of the counter and storing the value in the one or more memories, or accessing an address of the one or more memories indicated by the pointer and at which a value corresponding to the first VLAN ID is stored.

Example 36 includes the non-transitory computer-readable medium of Example 35, where, to perform the second instance of the discovery procedure for the first VLAN ID, the operations include obtaining the indicator corresponding to the first VLAN ID.

Example 37 includes the non-transitory computer-readable medium of Example 36, where, to obtain the indicator, the operations include: retrieving the index stored in one or more memories, retrieving a value of the counter stored in the one or more memories, or accessing the address of the one or more memories indicated by the pointer and at which the value corresponding to the first VLAN ID is stored.

Example 38 includes the non-transitory computer-readable medium of any of Examples 33 to 37, where, to perform the discovery procedure, the operations include: sending a discovery message to the server device; receiving an offer message from the server device in response to the sent discovery message; sending a request message to the server device in response to receipt of the offer message; and determining whether to associate an IP address with a respective VLAN ID of the plurality of VLAN IDs based on an ACK message received from the server device in response to the sent request message.

Example 39 includes the non-transitory computer-readable medium of Example 38, where the operations further include associating a first IP address with the first VLAN ID based on performing the second instance of the discovery procedure.

Example 40 includes the non-transitory computer-readable medium of any of Examples 33 to 39, where the operations further include monitoring the Ethernet channel, where monitoring the Ethernet channel includes: measuring the signal quality of the Ethernet channel; and comparing the signal quality of the Ethernet channel to one or more thresholds, the one or more thresholds including the first threshold, the second threshold, or a combination thereof.

Example 41 includes the non-transitory computer-readable medium of any of Examples 33 to 40, where: the signal quality of the Ethernet channel includes a bit error rate, the first threshold corresponds to a first bit error rate of a first data transmission over the Ethernet channel, and the second threshold corresponds to a second bit error rate of a second data transmission over the Ethernet channel.

Example 42 includes the non-transitory computer-readable medium of any of Examples 33 to 41, where the operations further include determining whether the Ethernet port is a trunk port or an access port, where, to select the first VLAN ID, the operations include selecting the first VLAN ID in response to determining that the Ethernet port is a trunk port.

Example 43 includes the non-transitory computer-readable medium of any of Examples 33 to 42, where the non-transitory computer-readable medium is included in a device, where the device includes a first DHCP device, and where the server device includes a second DHCP device.

Example 44 includes the non-transitory computer-readable medium of any of Examples 33 to 43, where, to perform the second instance of the discovery procedure, the operations include determining, based on the performance of the second instance of the discovery procedure, whether to associate an IP address with the first VLAN ID.

Example 45 includes the non-transitory computer-readable medium of Example 44, where the operations further include: in response to receiving an acknowledgement message from the server device during the performance of the second instance of the discovery procedure, associating the IP address with the first VLAN ID; performing M-plane communication with the server device via a VLAN corresponding to the first VLAN ID; and establishing communication with the server device in response to the performance of the M-plane communication.

Example 46 includes the non-transitory computer-readable medium of any of Examples 33 to 45, where: the non-transitory computer-readable medium is included in a device that includes a plurality of Ethernet ports, the plurality of VLAN IDs include a range of VLAN ID values from one to four thousand and ninety-four, and the discovery procedure comports with an ETSI TS 104 023 standard, an RFC.2131 standard, or a combination thereof.

Example 47 includes the non-transitory computer-readable medium of Example 46, where the operations further include performing the discovery procedure for a second Ethernet port of the plurality of Ethernet ports, and where, to perform the discovery procedure for the second Ethernet port, the operations include performing a third instance of the discovery procedure, the third instance performed concurrently with the second instance.

Example 48 includes the non-transitory computer-readable medium of any of Examples 33 to 47, where the operations further include: measuring the signal quality of the Ethernet channel; and comparing the signal quality of the Ethernet channel to one or more thresholds, the one or more thresholds including the first threshold, the second threshold, or a combination thereof.

According to Example 49, an apparatus includes means for selecting, for a discovery procedure associated with an Ethernet port of a client device, a first VLAN ID from among a plurality of VLAN IDs; means for determining, during performance of a first instance of the discovery procedure for the first VLAN ID, that a signal quality of an Ethernet channel satisfies a first threshold, the Ethernet channel established with a server device; means for halting, based on determining that the signal quality of the Ethernet channel satisfies the first threshold, performance of the first instance of the discovery procedure; and means for performing, based on determining that the signal quality of the Ethernet channel satisfies a second threshold, a second instance of the discovery procedure for the first VLAN ID.

Example 50 includes the apparatus of Example 49, where the means for halting the performance of the first instance includes: means for identifying an indicator corresponding to the first VLAN ID; and means for stopping the performance of the first instance of the discovery procedure.

Example 51 includes the apparatus of Example 49 or Example 50, where: the indicator includes an index, a counter, or a pointer, and the means for identifying the indicator includes: means for storing the index in one or more memories, means for incrementing a value of the counter and means for storing the value in the one or more memories, or means for accessing an address of the one or more memories indicated by the pointer and at which a value corresponding to the first VLAN ID is stored.

Example 52 includes the apparatus of Example 51, where the means for performing the second instance of the discovery procedure for the first VLAN ID includes means for obtaining the indicator corresponding to the first VLAN ID.

Example 53 includes the apparatus of Example 52, where the means for obtaining the indicator includes: means for retrieving the index stored in one or more memories, means for retrieving a value of the counter stored in the one or more memories, or means for accessing the address of the one or more memories indicated by the pointer and at which the value corresponding to the first VLAN ID is stored.

Example 54 includes the apparatus of any of Examples 49 to 53, where the means for performing the discovery procedure includes: means for sending a discovery message to the server device; means for receiving an offer message from the server device in response to the sent discovery message; means for sending a request message to the server device in response to receipt of the offer message; and means for determining whether to associate an IP address with a respective VLAN ID of the plurality of VLAN IDs based on an ACK message received from the server device in response to the sent request message.

Example 55 includes the apparatus of Example 54, where the apparatus further includes means for associating a first IP address with the first VLAN ID based on performance of the second instance of the discovery procedure.

Example 56 includes the apparatus of any of Examples 49 to 55, and further includes means for monitoring the Ethernet channel, where the means for monitoring the Ethernet channel includes: means for measuring the signal quality of the Ethernet channel; and means for comparing the signal quality of the Ethernet channel to one or more thresholds, the one or more thresholds including the first threshold, the second threshold, or a combination thereof.

Example 57 includes the apparatus of any of Examples 49 to 56, where: the signal quality of the Ethernet channel includes a bit error rate, the first threshold corresponds to a first bit error rate of a first data transmission over the Ethernet channel, and the second threshold corresponds to a second bit error rate of a second data transmission over the Ethernet channel.

Example 58 includes the apparatus of any of Examples 49 to 57, and further includes means for determining whether the Ethernet port is a trunk port or an access port, where the means for selecting the first VLAN ID includes means for selecting the first VLAN ID in response to a determination that the Ethernet port is a trunk port.

Example 59 includes the apparatus of any of Examples 49 to 58, where the apparatus includes a first DHCP device, and the server device includes a second DHCP device.

Example 60 includes the apparatus of any of Examples 49 to 58, where the means for performing the second instance of the discovery procedure includes means for determining, based on the performance of the second instance of the discovery procedure, whether to associate an IP address with the first VLAN ID.

Example 61 includes the apparatus of Example 60, and further includes means for associating, in response to receipt of an acknowledgement message from the server device during the performance of the second instance of the discovery procedure, the IP address with the first VLAN ID; means for associating the IP address with the first VLAN ID; means for perform M-plane communication with the server device via a VLAN corresponding to the first VLAN ID; and means for establishing communication with the server device in response to the performance of the M-plane communication.

Example 62 includes the apparatus of any of Examples 49 to 61, and further includes a plurality of Ethernet ports, where the plurality of VLAN IDs include a range of VLAN ID values from one to four thousand and ninety-four, and where the discovery procedure comports with an ETSI TS 104 023 standard, an RFC.2131 standard, or a combination thereof.

Example 63 includes the apparatus of Example 62 and further includes means for performing the discovery procedure for a second Ethernet port of the plurality of Ethernet ports, where the means for performing the discovery procedure for the second Ethernet port includes means for performing a third instance of the discovery procedure, the third instance performed concurrently with the second instance.

Example 64 includes the apparatus of any of Examples 49 to 63, and further includes means for measuring the signal quality of the Ethernet channel; and means for comparing the signal quality of the Ethernet channel to one or more thresholds, the one or more thresholds including the first threshold, the second threshold, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logics, logical blocks, modules, circuits, and algorithm processes described in connection with the disclosure herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include random access memory (RAM), read-only memory (ROM), electronically erasable programable ROM (EEPROM), compact disc (CD) ROM (CD-ROM), or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product or a computer-readable storage device.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. Such a threshold may be a single value or a range of values. As an illustrative example, a value may satisfy a threshold range of values if the value is between two threshold values, or equal to one of the two threshold values, that define the threshold range of values.

No element, act, or instruction used herein should be construed as critical or essential unless explicitly described as such. Also, as used herein, the articles “a” and “an” are intended to include one or more items and may be used interchangeably with “one or more.” It should be understood that “one or more” is equivalent to “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Similarly, the phrase “in accordance with” is intended to mean “based on or otherwise in association with” unless explicitly stated otherwise.

The previous description of the disclosure is provided to enable any person skilled in the art to make or use the disclosure. Various modifications to the implementations described in this disclosure may be readily apparent to those skilled in the art, and the generic principles defined herein may be applied to other variations without departing from the scope of this disclosure. Thus, the disclosure is not intended to be limited to the examples and designs described herein but is to be accorded the widest scope consistent with the principles and novel features disclosed herein.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A device comprising:
a processing system coupled to a plurality of Ethernet ports, the processing system including one or more processors and one or more memories coupled to the one or more processors, the processing system configured to:
select, for a discovery procedure associated with an Ethernet port of the plurality of Ethernet ports, a first virtual local area network (VLAN) identity (ID) from among a plurality of VLAN IDs;
during performance of a first instance of the discovery procedure for the first VLAN ID, detect that a signal quality of an Ethernet channel satisfies a first threshold, the Ethernet channel established with a server device;
based on a determination that the signal quality of the Ethernet channel satisfies the first threshold, halt the performance of the first instance of the discovery procedure; and
based on a determination that the signal quality of the Ethernet channel satisfies a second threshold, perform a second instance of the discovery procedure for the first VLAN ID.

2. The device of claim 1, wherein, to halt the performance of the first instance, the processing system is configured to:
identify an indicator corresponding to the first VLAN ID; and
stop the performance of the first instance of the discovery procedure.

3. The device of claim 2, wherein:
the indicator includes an index, a counter, or a pointer, and
to identify the indicator, the processing system is configured to:
store the index in the one or more memories,
increment a value of the counter and store the value in the one or more memories, or
access an address of the one or more memories indicated by the pointer and at which a value corresponding to the first VLAN ID is stored.

4. The device of claim 3, wherein, to perform the second instance of the discovery procedure for the first VLAN ID, the processing system is configured to obtain the indicator corresponding to the first VLAN ID.

5. The device of claim 4, wherein, to obtain the indicator, the processing system is configured to:
retrieve the index stored in the one or more memories,
retrieve a value of the counter stored in the one or more memories, or
access the address of the one or more memories indicated by the pointer and at which the value corresponding to the first VLAN ID is stored.

6. The device of claim 1, wherein, to perform the discovery procedure, the processing system is configured to:
send a discovery message to the server device;
receive an offer message from the server device in response to the sent discovery message;
send a request message to the server device in response to receipt of the offer message; and
determine whether to associate an Internet Protocol (IP) address with a respective VLAN ID of the plurality of VLAN IDs based on an acknowledgment (ACK) message received from the server device in response to the sent request message.

7. The device of claim 1, wherein:
the processing system is further configured to monitor the Ethernet channel, and
to monitor the Ethernet channel, the processing system is configured to:
measure the signal quality of the Ethernet channel; and
compare the signal quality of the Ethernet channel to one or more thresholds, the one or more thresholds including the first threshold, the second threshold, or a combination thereof.

8. The device of claim 1, wherein:
the signal quality of the Ethernet channel includes a bit error rate,
the first threshold corresponds to a first bit error rate of a first data transmission over the Ethernet channel, and
the second threshold corresponds to a second bit error rate of a second data transmission over the Ethernet channel.

9. The device of claim 1, wherein:
the processing system is further configured to determine whether the Ethernet port is a trunk port or an access port, and
to select the first VLAN ID, the processing system is configured to select the first VLAN ID in response to a determination that the Ethernet port is a trunk port.

10. The device of claim 1, wherein the device includes a first dynamic host configuration protocol (DHCP) device, and the server device includes a second DHCP device.

11. The device of claim 1, wherein, to perform the second instance of the discovery procedure, the processing system is configured to determine, based on the performance of the second instance of the discovery procedure, whether to associate an internet protocol (IP) address with the first VLAN ID.

12. The device of claim 11, wherein the processing system is further configured to:
in response to receipt of an acknowledgement message from the server device during the performance of the second instance of the discovery procedure, associate the IP address with the first VLAN ID;
perform management (M)-plane communication with the server device via a VLAN corresponding to the first VLAN ID; and
establish communication with the server device in response to the performance of the M-plane communication.

13. The device of claim 1, further comprising:
the plurality of Ethernet ports,
wherein the plurality of VLAN IDs include a range of VLAN ID values from one to four thousand and ninety-four, and
wherein the discovery procedure comports with an ETSI TS 104 023 standard, an RFC.2131 standard, or a combination thereof.

14. The device of claim 1, wherein:
the processing system is further configured to perform the discovery procedure for a second Ethernet port of the plurality of Ethernet ports, and
to perform the discovery procedure for the second Ethernet port, the processing system is configured to perform a third instance of the discovery procedure, the third instance performed concurrently with the second instance.

15. A method performed by a client device, the method comprising:
selecting, for a discovery procedure associated with an Ethernet port of the client device, a first virtual local area network (VLAN) identity (ID) from among a plurality of VLAN IDs;
during performance of a first instance of the discovery procedure for the first VLAN ID, determining that a signal quality of an Ethernet channel satisfies a first threshold, the Ethernet channel established with a server device;
based on determining that the signal quality of the Ethernet channel satisfies the first threshold, halting performing the first instance of the discovery procedure; and
based on determining that the signal quality of the Ethernet channel satisfies a second threshold, performing a second instance of the discovery procedure for the first VLAN ID.

16. The method of claim 15, wherein halting performing the first instance includes:
identifying an indicator corresponding to the first VLAN ID; and
stopping performing the first instance of the discovery procedure.

17. The method of claim 16, wherein performing the discovery procedure includes:
sending a discovery message to the server device;
receiving an offer message from the server device in response to sending the discovery message;
sending a request message to the server device in response to receiving the offer message; and
determining whether to associate an Internet Protocol (IP) address with a respective VLAN ID based on an acknowledgment (ACK) message received from the server device in response to sending the request message.

18. The method of claim 17, further comprising associating a first IP address with the first VLAN ID based on performing the second instance of the discovery procedure.

19. A non-transitory computer-readable medium storing instructions that are executable by one or more processors to cause the one or more processors to perform operations, the operations including:
selecting, for a discovery procedure associated with an Ethernet port, a first virtual local area network (VLAN) identity (ID) from among a plurality of VLAN IDs;
during performance of a first instance of the discovery procedure for the first VLAN ID, detecting that a signal quality of an Ethernet channel satisfies a first threshold, the Ethernet channel established with a server device;
based on detecting that the signal quality of the Ethernet channel satisfies the first threshold, halting performance of the first instance of the discovery procedure; and
based on detecting that the signal quality of the Ethernet channel satisfies a second threshold performing a second instance of the discovery procedure for the first VLAN ID.

20. The non-transitory computer-readable medium of claim 19, wherein the operations further include:
measuring the signal quality of the Ethernet channel; and
comparing the signal quality of the Ethernet channel to one or more thresholds, the one or more thresholds including the first threshold, the second threshold, or a combination thereof.
